(19) United States
(12) Patent Application Publication
(10) Pub. No.: US 2026/0278245 A1
(43) Pub. Date: Sep. 17, 2026

(54) CONTENT OPTIMIZATION USING ARTIFICIAL INTELLIGENCE AGENTS

(71) Applicant: Adobe Inc., San Jose, CA (US)

(72) Inventors: Ronald Oribio, Austin, TX (US); Niccolo Toccane, Belluno (IT); Mustafa Doga Dogan, Basel (CH); Alina Rublea, Basel (CH); Meryll Blanchet, Colmar (FR); Tobias Reiss, Munich (DE); Aanisha Bhattacharyya, Uttar Pradesh (IN); Yaman Kumar, New Delhi (IN)

(73) Assignee: Adobe Inc., San Jose, CA (US)

(21) Appl. No.: 19/077,503

(22) Filed: Mar. 12, 2025

(51) Int. Cl. G06F 40/143

(52) U.S. Cl. CPC G06F 40/143

(57) ABSTRACT

Techniques for optimizing digital content information are described. A conversion detection module identifies a set of conversion elements encoded into digital content information using a machine learning (ML) model. A content selection module selects a candidate conversion element from the set of conversion elements. A content block module identifies a candidate content block comprising the candidate conversion element and context information associated with the candidate conversion element. A prompt generation module generates a prompt for a generative artificial intelligence (GAI) agent, the prompt including the candidate content block and instructions to generate a content block variant comprising the candidate conversion element and a context information variant for the context information associated with the candidate conversion element. A content update module receives the content block variant from the GAI agent. The content update module presents the content block variant on a graphical user interface (GUI). Other embodiments are described and claimed.

### BACKGROUND

A web page is generated through a collaborative process that starts with planning and design, where the layout, branding, and functionality are defined to meet business goals and user needs. Designers create mockups and wireframes, which are then translated into code by developers using hypertext markup language (HTML) for structure, cascading style sheets (CSS) for styling, and JavaScript for interactivity. Content is integrated, often through a Content Management System (CMS), to ensure the page is dynamic and easily updatable. Once developed, the site undergoes rigorous testing across different devices and browsers to ensure compatibility and optimal performance before being deployed to a live server, making it accessible to users worldwide. This process is often time-consuming and requires a significant amount of manual effort by a design team. Therefore, there is a substantial need for automation to generate a web page, such as web page design, content generation, testing, deployment, and updates.

### SUMMARY

Embodiments are generally directed to techniques for automatically optimizing digital content information presented by digital media using artificial intelligence (AI) agents. Some embodiments are particularly directed to a novel end-to-end framework for optimizing digital content information presented by a web page to increase user engagement with conversion elements associated with the digital content information. An example of digital content information includes a web page for a website. An example of a conversion element is a graphical user interface (GUI) element that when activated by an input device generates an interaction event. Examples of a conversion element include an input field, checkboxes, radio buttons, submit buttons, hyperlinks, forms, call-to-action (CTA) button, and the like.

The framework integrates generative AI (GAI) models, real use monitoring (RUM) analytics, and AI agents to automatically optimize content information for a web page of a website. For example, the GAI assists in auto-detection of conversion elements and associated content information of a web page. The RUM analytics assist in selecting conversion elements suitable for optimization given a defined performance metric (e.g., click-through rate or CTR). The RUM analytics also assist in selecting AI agents suitable for generating variants of the content information to increase the given metric. An example of an AI agent comprises a software entity designed to perform tasks, make decisions, or solve problems using artificial intelligence techniques.

In some embodiments, a machine learning (ML) model such as a large language model (LLM) automatically identifies conversion elements within a web page and selects a candidate conversion element using benchmarked interaction rates. Once identified, an AI agent analyzes the candidate conversion element and associated content information to suggest improvements to the content information designed to increase a performance metric associated with the candidate conversion element (e.g., a CTR). For example, the AI agent is implemented using a GAI model such as an LLM-based agent.

In some embodiments, an AI agent is a persona-based multi-agent simulation with a defined set of characteristics, traits, and behaviors that shape how the AI agent interacts with users and represents itself. A persona adds a human-like dimension to agent interactions. In a particular embodiment, an audience persona simulates a personality, characteristic or trait of a human member of a target audience segment for the web page. For example, assume a web page is designed for a travel website. Examples of audience personas include a young professional working at a start-up renewable energy company, a parent working as a schoolteacher planning a trip, a travel influencer for urban destinations, a budget conscious traveler, and so forth. The audience personas engage in a structured multi-agent dialogue with a human user to collaborate on modifying content information for a web page in a chat-like manner. The audience personas provide qualitative feedback on how the conversion elements can be improved to better align with their expectations and motivations. The synthesized feedback is then used to iteratively generate optimized multimedia content variations that maximize engagement across diverse audience segments. The generated content variations are then deployed using an experimental system to perform experiments, such as A/B testing, for the various content variations to assess real-world performance.

The AI framework allows a human user (e.g., a website designer) to engage in an iterative process that enables continuous, data-driven optimization of a web page. As a result, embodiments provide a scalable, automation-driven methodology for enhancing content effectiveness, minimizing manual intervention, and leveraging AI-driven insights to improve web-based conversion outcomes.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system in accordance with one embodiment.

FIG. 2 illustrates a logic diagram in accordance with one embodiment.

FIG. 3 illustrates a logic diagram in accordance with one embodiment.

FIG. 4 illustrates a logic diagram in accordance with one embodiment.

FIG. 5 illustrates a transformer model in accordance with one embodiment.

FIG. 6 illustrates a logic diagram in accordance with one embodiment.

FIG. 7 illustrates a logic flow in accordance with one embodiment.

FIG. 8 illustrates a logic flow in accordance with one embodiment.

FIG. 9 illustrates a logic flow in accordance with one embodiment.

FIG. 10 illustrates a graphical user interface (GUI) view in accordance with one embodiment.

FIG. 11 illustrates a logic flow in accordance with one embodiment.

FIG. 12 illustrates a logic flow in accordance with one embodiment.

FIG. 13 illustrates a system in accordance with one embodiment.

### DETAILED DESCRIPTION

Embodiments are generally directed to techniques for automatically optimizing digital content information presented by digital media using artificial intelligence (AI) agents. An example of digital media is a web page for a website for presentation by an application program on an electronic display of an electronic device. In some embodiments, a content management system (CMS) implements an agentic workflow using a plurality of AI agents to optimize presentation of a web page for web site. The CMS uses a plurality of machine learning (ML) models to detect portions of the web page that are suitable for optimization. For example, a web page has a conversion element, such as a graphical user interface (GUI) element that when activated by a user generates an interaction event. The web page includes digital content information designed to lead a user in activating the conversion element, such as a request for more information about a product or service offered by a company. AI agents implemented by an ML model such as a large language model (LLM) are prompted to improve the digital content information proximate to the conversion element to increase a probability of an interaction event. The prompt includes instructions for the LLM-based agents to generate improvements, referred to herein as “variants,” according to different personas with human-like qualities that mimic a target audience member of the web page. An experimental sub-system tests a plurality of variants in real-time. The CMS selects a variant to replace the original digital content information associated with the conversion element using a set of metrics, such as a click-through-rate (CTR), conversion rate, and the like. Embodiments are not limited to this example.

Embodiments are generally directed to techniques for automatically optimizing digital content information presented by digital media using artificial intelligence (AI) agents. An example of digital media is a web page for a website for presentation by an application program on an electronic display of an electronic device. Examples of application programs include web browsers, client applications to access online systems, server applications to deliver website content and serve web pages, and so forth. Some embodiments optimize any digital content information suitable for presentation by any type of digital media. Embodiments are not limited to this example.

Some embodiments are particularly directed to a novel end-to-end framework for optimizing digital content information presented by a web page to increase user engagement with conversion elements associated with the digital content information. A conversion element is a specific component on a web page that is strategically designed to prompt visitors to take a desired action, like making a purchase, subscribing to a service, filling out a contact form, or selecting a hyperlink to learn more. An example of a conversion element is an interactive element on a graphical user interface (GUI) to collect data from users. Examples of an interactive element includes an input field, checkboxes, radio buttons, submit buttons, hyperlinks, forms, call-to-action (CTA) button, promotional banner, and the like. These elements assist in converting casual browsers into engaged leads or customers by clearly communicating benefits and guiding users through the conversion funnel. Effective conversion elements are visually prominent, feature concise messaging, and are integrated seamlessly into the overall design, ensuring that the user experience is smooth and compelling enough to drive the intended behavior.

Conversion elements of a web page are often associated with context information. Context information for a conversion element refers to the surrounding data and environmental cues that influence how users perceive and interact with that element. This includes details such as the page layout, content context, multimedia content information, user demographics, device type, browsing history, and real-time behavioral signals. By understanding this broader context, marketers and designers can optimize the placement, design, and messaging of the conversion element, ensuring it resonates with the audience's needs and enhances its overall effectiveness in driving the desired action.

Designing context information for a web page of a website remains a challenging task. A web page is typically generated through a collaborative process that starts with planning and design, where the layout, branding, and functionality are defined to meet business goals and user needs. Designers create mockups and wireframes, which are then translated into code by developers using hypertext markup language (HTML) for structure, cascading style sheets (CSS) for styling, and JavaScript for interactivity. Content is integrated, often through a Content Management System (CMS), to ensure the page is dynamic and easily updatable. Once developed, the site undergoes rigorous testing across different devices and browsers to ensure compatibility and optimal performance before being deployed to a live server, making it accessible to users worldwide. This process is often time-consuming, requires a significant amount of manual effort by a design team, and typically occurs in separate phases using different software programs.

Embodiments solve these and other technical problems. Embodiments implement various automation techniques to automatically generate or optimize the design, development, and deployment of a web page. Some embodiments use an AI framework to optimize a web page that integrates generative AI (GAI), real use monitoring (RUM) analytics, AI agents to generate variants of context information for a web page, and an experimental sub-system to test the variants. For example, the GAI is an LLM that assists in auto-detection of conversion elements and associated context information of a web page. The RUM analytics assist in selecting candidate conversion elements suitable for optimization given a defined metric (e.g., click-through rate). The RUM analytics also assist in selecting AI agents with various personas suitable for providing insights for the candidate conversion elements. The selected AI agents generate variants of the context information for the candidate conversion elements to increase the given metric. An experimental sub-system performs A/B testing on the variants, collects real-time measurements, and selects a variant suitable for deployment by the web page. A production system then deploys the selected variant for the web page for presentation to an audience of users.

In some embodiments, a content management system (CMS) implements an AI framework designed to optimize content information rendered by a web page for a website. For example, the CMS implements a GAI sub-system to identify conversion elements of a web page, select a candidate conversion element suitable for optimization, retrieve context information for the candidate conversion element, and generate one or more variants of the context information to increase a metric for the conversion element. Examples of variants for the context information includes modifications to a page layout (e.g., HTML code, CSS code, etc.), multimedia content information (e.g., text, audio, image, video, animation, etc.) for a conversion element, changes to the conversion element (e.g., switching from a button to link), suggesting different user demographics for the conversion element, and the like. A design goal of the variant is to drive a defined action as measured by a given metric, such as causing a user to interact with a conversion element as measured by a click-through-rate (CTR).

Specifically, the CMS implements a GAI sub-system using one or more machine learning (ML) models. Examples of ML models include artificial neural networks (ANN), deep neural networks (DNN), transformers, generative adversarial networks (GAN), and the like. Different ML models are implemented to generate different types of context information for a conversion element. For example, the GAI sub-system implements a text-based ML model to generate textual information using natural language expressions, an image-based ML model to generate visual information, a video-based ML model to generate video information, an audio-based ML model to generate audio information, an animation-based ML model to generate animation information, or any combinations thereof.

The GAI sub-system uses different ML models for different tasks. For example, a text-based ML model such as a large language model (LLM) is used to generate textual information using natural language expressions for variants of original textual information in the contextual information of a conversion element. An LLM is designed to understand and generate human-like content by leveraging deep learning techniques on extensive datasets. These models, built on architectures like transformers, are trained on vast amounts of textual data to capture linguistic patterns, semantic relationships, and contextual nuances. As a result, LLMs can perform a variety of tasks such as answering questions, translating languages, summarizing content, and even engaging in coherent conversations. An LLM is used to interact with a human user in a chat-like manner to receive instructions and feedback from the human user. The LLM is also used to generate textual information for responses to the human user and variants for the original textual information of a conversion element. In another example, an image-based ML model such as DALL-E, Stable Diffusion, or Midjourney is used to generate visual information for variants of original visual information in the contextual information of a conversion element. Image-based ML models create visual content such as creative and high-quality images from textual descriptions or through learned patterns. These are merely some examples. Different ML models for different modalities are combined to generate multimedia variants of context information for a conversion element, including textual information, visual information, audio information, video information, animation information, and the like. In some cases, different modalities are generated using a multimodal ML model. Embodiments are not limited to a particular ML model or a particular modality for the ML model.

In some embodiments, the CMS implements a data analytics sub-system to collect and use analytics, such as RUM analytics, to assist in selecting candidate conversion elements suitable for optimization given a defined metric (e.g., click-through rate). RUM analytics in the context of machine learning involves collecting and analyzing performance data from real users interacting with ML-powered applications in their natural environments. This approach monitors key metrics such as response times, error rates, and user engagement, providing insights into how the deployed models perform under actual usage conditions. By capturing this real-world feedback, developers and data scientists can identify issues like model drift, latency problems, or unexpected biases that might not surface during controlled testing. Ultimately, RUM analytics helps ensure that machine learning systems deliver a reliable, optimal user experience and supports ongoing improvements and maintenance in production. The analytics sub-system receives the RUM analytics from various data sources designed to collect the RUM analytics, such as tracking and analyzing performance metrics as experienced by actual users. Examples of performance metrics include measuring page load times, monitoring error rates, collecting code exceptions (e.g., JavaScript exceptions), and user engagement metrics. Examples of user engagement metrics include click-through-rates (CTR), conversion rates (CVR), dwell times, bounce rates, conversion events, impressions, and so forth. The CMS analyzes the performance metrics, particularly the user engagement metrics, to perform tasks such as identifying conversion elements from a web page that are suitable for optimization. For example, the CMS selects a set of conversion elements from a web page based on RUM data. The CMS also selects a subset of conversion elements from the set of conversion elements based on RUM data. For example, the CMS selects a subset of conversion elements associated with a lower CTR score, as compared to a defined threshold value, as indicated by the RUM data. The subset of conversion elements become candidate conversion elements for further inspection and analysis.

In some embodiments, for example, the CMS uses the data analytics sub-system to assist in selecting AI agents suitable for providing insights for candidate conversion elements. An AI agent is an autonomous system that perceives its environment, processes information using algorithms, and takes actions to achieve specific goals. It interacts with its surroundings through sensors and actuators, employing techniques from machine learning, decision theory, and sometimes reinforcement learning to adapt and optimize its behavior over time. AI agents can operate in various domains where they continuously analyze data, make decisions, and learn from feedback to improve performance. Specifically, the CMS selects one or more AI agents based, at least in part, on activity data of users. The AI agents simulate actions or feedback of an individual or group of individuals (e.g., human beings) from various target audience segments of a web page. For example, assume a web page advertises an online learning course for working professionals in the aerospace industry and has a target audience segment comprising individuals between the ages of 25-45 with an undergraduate degree in aerospace engineering. The CMS selects an AI agent for simulating a 30 year old female with an undergraduate degree in aerospace engineering working at a full-time job in a given geographic area.

In some embodiments, for example, an AI agent is designed to operate with a defined persona referred to as an “audience persona.” An audience persona represents a human-like personality for an AI agent to assist in guiding its interactions with human users and/or digital content. An audience persona for an AI agent is implemented by generating and storing a personality profile for each AI agent. A personality profile defines a given audience persona by storing a set of parameters representing human-like characteristics, traits, preferences, behaviors, attributes, tones, styles, perspectives, properties, and the like. This crafted identity helps ensure that the AI communicates in a consistent, relatable manner, aligning with user expectations, audience expectations, and the intended brand image.

In some embodiments, the CMS selects one or more AI agents with audience personas comprising personality profiles designed for simulating one or more individuals from various audience segments intended for viewing a web page and interacting with a conversion element. As a result, an AI agent with a given audience persona interacts with a human designer in a manner that is similar to an actual human from the intended audience. This includes providing responses similar to a human personality, analyzing information from the perspective of a human personality, generating content as a human personality, and other actions. By incorporating human-like attributes such as friendliness, professionalism, humor, or formality, the audience persona not only enhances user engagement but also influences how effectively the agent fulfills its role in providing variants and feedback concerning context information for conversion elements of a web page.

In some embodiments, the audience personas generate variants of the context information for the candidate conversion elements to increase a given metric. For example, assume a web page is designed for a travel website and it has a conversion element with a hyperlink to an advertisement for a travel company offering a travel service. The conversion element is positioned on a web page (e.g., top, bottom, left, right, middle, etc.) and is surrounded by digital content information that provides context for the conversion element (e.g., above, below, beside, in-line, proximate, near, etc.). In this example, assume context information within a defined distance of the position of the conversion element includes textual information describing a travel destination and visual information such as an image of the destination positioned above the conversion element on the web page. The CMS uses RUM data to select AI agents provisioned with audience personas such as a young professional working at a start-up renewable energy company, a parent working as a schoolteacher planning a trip for her family, a travel influencer for urban destinations, a budget conscious traveler, and so forth. The audience personas engage in a structured multi-agent dialogue with a human user, such as a website designer, to collaborate on modifying content information for a web page in a chat-like manner via a GUI chat interface. The audience personas provide qualitative feedback on how the context information surrounding the conversion element can be improved to better align with their expectations and motivations. The synthesized feedback is then used to iteratively generate optimized multimedia content variations that maximize engagement across diverse audience segments.

In some embodiments, an AI agent is implemented as an LLM-based agent. For example, the CMS generates a prompt for the LLM using prompt engineering techniques, where the prompt includes a personality profile of an audience persona, content information from the web page, context information from the web page, instructions to generate responses and variants using the audience persona, one-shot or few-shot examples, website descriptions, audience descriptions, and other types of information. In some cases, the CMS generates the prompt using one or more prompt templates to accelerate prompt generation. The LLM receives the prompt as input, and it operates as an AI agent imbued with characteristics of the personality profile to generate a response consistent with the audience persona. For example, if the audience persona is a young professional then the LLM will generate a response that simulates a response using a tone, language, humor, insights, and other personality traits of a young professional. The response includes a variant of the content information, such as context information variants for a conversion element, which is then presented on a GUI of an electronic display of an electronic device for review by a human user. The human user can then select one or more context information variants for experimental testing.

An experimental sub-system performs experimental testing on the variants, collects real-time measurements such as RUM data, and selects a variant suitable for deployment by the web page. In some embodiments, the experimental sub-system uses A/B testing to experiment on variants of digital content information, including the context information variants for a conversion element, for a web page. A/B testing is an experimental approach where different versions of a page are shown to separate groups of users to determine which design or content performs better against specific performance metrics, such as conversion rates or user engagement. By randomly assigning visitors to different variants, entities (e.g., businesses, website designers, etc.) collect quantitative data that reveal how changes in design, layout, or copy influence user behavior. The results are then analyzed using statistical methods to confirm whether observed differences are significant, enabling data-driven decisions to optimize and deploy the web page for improved performance and user experience.

For example, once a human user selects multiple variants for testing, the variants are passed to the experimental sub-system for A/B testing. Assume a travel website aims to boost the number of bookings through a prominent call-to-action (CTA) conversion element. In version A of the web page, the CTA button is placed at the top of the page with a bold, contrasting color and a straightforward message like “Book Your Dream Vacation Today,” paired with a high-quality image of a relaxing beach resort. In version B, the page features a full-screen video background showcasing popular destinations with the CTA overlay reading “Discover Your Next Adventure,” enhanced by subtle animations to draw attention. Visitors are randomly directed to one of the two versions, and metrics such as click-through rates on the CTA, time spent on the page, and completed bookings are monitored. By comparing the performance data from both variants, the experimental sub-system can determine which design more effectively drives conversions for the travel website, thereby allowing for a data-driven decision to adopt the more successful approach.

Once the experimental sub-system selects a variant based on the performance data, the experimental sub-system passes the variant to a production server for a massive cloud-based online system. The production server then deploys the selected variant as a current optimization of the web page for presentation to its intended audience as part of a website. The optimization process is performed on a continuous, periodic, or a periodic basis to ensure that context information for conversion elements of a web page of a website is continuously improved upon to drive members of an audience segment to interact with the conversion elements to improve one or more performance metrics.

In one embodiment, for example, a CMS implements circuitry executing logic and/or instructions for identifying, by a conversion detector module, a set of conversion elements encoded into digital content information using a machine learning (ML) model. The circuitry is for generating, by a conversion metric module, a set of performance metrics for the set of conversion elements using real use monitoring (RUM) analytics. The circuitry is for selecting, by a content selection module, a candidate conversion element from the set of conversion elements based on the set of performance metrics. The circuitry is for determining, by a content block module, a candidate content block includes the candidate conversion element and context information associated with the candidate conversion element. The circuitry is for generating, by a prompt generation module, a prompt for an artificial intelligence (AI) agent, the prompt including the candidate content block and instructions to generate a content block variant includes the candidate conversion element and a context information variant for the context information associated with the candidate conversion element. The circuitry is for presenting, by a content update module, the content block variant on a graphical user interface (GUI). Other embodiments are described and claimed.

Embodiments provide technical solutions to various technical problems associated with conventional techniques for optimizing a web page. For example, a CMS for an online system automates a content-oriented agentic workflow to optimize context information for a conversion element of a web page using GAI techniques, RUM analytics, and AI agents with diverse audience personas simulating human members of a target audience segment for the web page. Further, the CMS integrates an experimental sub-system to perform experiments using various testing algorithms (e.g., A/B testing) on variations of content in order to select a variant that drives higher user engagement. This improves on conventional systems that rely on human generated context information based on feedback from focus groups and marketing campaigns without real-time feedback systems. Further, the CMS uses RUM analytics, for a privacy first approach, to auto-select conversion elements in real-time (e.g., milliseconds to microseconds) or near real-time (e.g., microseconds to seconds), particularly those conversion elements with lower performance metrics (e.g., above or below a defined threshold). This improves on conventional systems using manually annotated data collected over larger time frames, such as hours, days, weeks or months. In addition, the CMS uses AI agents to provide feedback on context information for conversion elements. The AI agents simulate realistic audience members for digital content. This improves on the use of human focus groups organized by demographics for audience segments that cannot articulate reasons why current context information provides poor performance or creative variants to improve performance, particularly those that involve multimedia content beyond just textual information. In some cases, the CMS uses AI agents with different audience personas to get a diverse range of feedback for context information, where a human user such as a website designer can quickly select different audience personas to obtain different types of feedback. Moreover, the website designer can interact with the audience personas, via a chat interface, such as asking questions or giving directives to generate different variations in real-time. When there are multiple variants of interest, the website designer can select the multiple variants for automated testing by the experimental sub-system. The experimental sub-system is integrated with the CMS so that it can seamlessly test different variants, collect RUM data for the variants, determine whether a variant improves a performance metric in a statistically-significant way, and select a winning variant for the web page. If the variants do not produce statistically-significant results, the website designer can use the CMS to restart the optimization process or phases of the optimization process until statistically-significant results are obtained. As a result, the CMS provides an AI-driven framework that substantially improves operation of a computer system by efficiently using available resources, such as reducing compute cycles (e.g., CPU and GPU utilization), memory requirements, bandwidth consumption, bus utilization, application program interface (API) calls, power requirements particularly for battery operated devices, and other resources used for operations associated with optimizing a web page for a website, such as training ML models, performing inferencing by trained ML models, identifying conversion elements and associated context information, generating or selecting AI agents with audience personas, generating variants of context information and/or conversion elements, testing variants, and/or deploying variants to a back-end web server hosting web pages for a website. Embodiments provide other technical advantages as well.

### Term Definitions

As used herein, the term “content management system” refers to a system that creates, revises, updates, optimizes, deletes, or otherwise manages digital content information for an online system. In some embodiments, the content management system manages digital content information for a web page of a website for an online system.

As used herein, the term “conversion detector module” refers to a module that identifies, detects, extracts, or selects conversion elements encoded or embedded into digital content information. In some embodiments, the conversion detection module scans digital content information from a web page of a website in different formats, such as text, HTML code, XML code, CSS code, images (e.g., portable document format or snippets), and the like.

As used herein, the term “machine learning model” refers to a computational system that learns to make predictions or decisions by identifying patterns within data. In some embodiments, it starts with a training phase where the model processes historical data, adjusting its internal parameters to reduce errors and improve accuracy. By leveraging statistical methods and algorithms, such as regression, classification, clustering, or neural networks, the model gradually builds a representation of the underlying trends in the data. Once trained, it can generalize this knowledge to make informed predictions on new, unseen data, thereby automating complex tasks like image recognition, natural language processing, and recommendation systems.

As used herein, the term “conversion metric module” refers to a module that calculates metrics from data, such as activity data associated with a user, digital content information, a web page, a website, a conversion element, and so forth. In some embodiments, the conversion metric module calculates performance metrics.

As used herein, the term “performance metric” refers to a quantitative measure used to assess how effectively a website is functioning, particularly in areas such as speed, responsiveness, and user engagement. For example, page load time is a common performance metric that indicates how quickly a webpage fully loads for users. Faster load times generally contribute to a better user experience, higher search engine rankings, and improved conversion rates, while slower times can lead to increased bounce rates and diminished user satisfaction. Other relevant metrics might include uptime, bounce rate, and conversion rate, all of which provide valuable insights into the website's overall performance and areas for potential improvement.

As used herein, the term “real use monitoring analytics” refers to the process of collecting and analyzing data from actual users as they interact with a website in real time. Unlike synthetic monitoring, which uses scripted tests to simulate user behavior, RUM data captures detailed performance metrics from real-world scenarios, such as page load times, Time to First Byte (TTFB), First Contentful Paint (FCP), and Largest Contentful Paint (LCP). It also tracks user behaviors like navigation paths, click-through rates, and error occurrences, providing insights into how the website performs across different devices, browsers, and network conditions. This data helps website owners and developers identify performance bottlenecks, improve user experience, and optimize the overall functionality of the site.

As used herein, the term “content selection module” refers to a module to select a conversion element from a set of conversion elements. In some embodiments, the content selection module selects a candidate conversion element from the set of conversion elements based on the set of performance metrics.

As used herein, the term “content block module” refers to a module for identifying a block of content from digital content information. In some embodiments, the content block module identifies a candidate content block that includes the candidate conversion element and context information associated with the candidate conversion element.

As used herein, the term “conversion element” refers to a component on a web page that is strategically designed to prompt visitors to take a desired action, like making a purchase, subscribing to a service, or filling out a contact form. In some embodiments, a conversion element is an interactive element on a graphical user interface to collect data from users. Examples of an interactive element includes an input field, checkboxes, radio buttons, submit buttons, hyperlinks, forms, call-to-action button, promotional banner, and the like. These elements are key to converting casual browsers into engaged leads or customers by clearly communicating benefits and guiding users through the conversion funnel. Effective conversion elements are visually prominent, feature concise messaging, and are integrated seamlessly into the overall design, ensuring that the user experience is smooth and compelling enough to drive the intended behavior.

As used herein, the term “context information” refers to surrounding data and environmental cues that influence how users perceive and interact with a conversion element. In some embodiments, this includes details such as the page layout, content context, multimedia content information, user demographics, device type, browsing history, and real-time behavioral signals. By understanding this broader context, marketers and designers can optimize the placement, design, and messaging of the conversion element, ensuring it resonates with the audience's needs and enhances its overall effectiveness in driving the desired action.

As used herein, the term “prompt generation module” refers to a module designed to fill and complete prompt templates for an ML model, such as a large language model (LLM). In some embodiments, the prompt module leverages metadata associated with datasets and data in the datasets to fill and complete the prompt templates. The prompt module includes features to select templates from a library of templates, extract parameters from natural language input, populate the template with the extracted parameters, and provide the populated template to an LLM. In some embodiments, the prompt module is an LLM.

As used herein, the term “artificial intelligence agent” refers to an autonomous system that perceives its environment, processes information using algorithms, and takes actions to achieve specific goals. In some embodiments, it interacts with its surroundings through sensors and actuators, employing techniques from machine learning, decision theory, and sometimes reinforcement learning to adapt and optimize its behavior over time. AI agents can operate in various domains where they continuously analyze data, make decisions, and learn from feedback to improve performance. Specifically, the CMS selects one or more AI agents simulating one or more individuals (e.g., a human being) from various audience segments intended for a web page.

As used herein, the term “audience persona” refers to a personality profile to guide interactions of an AI agent with users and/or digital content. A personality profile defines a set of characteristics, traits, preferences, behaviors, attributes, tones, styles, perspectives, tones, properties, and the like. This crafted identity helps ensure that the AI communicates in a consistent, relatable manner, aligning with user expectations, audience expectations, and the intended brand image. In this case, the CMS agent selects one or more AI agents with audience personas simulating one or more individuals from various audience segments intended for a web page.

As used herein, the term “graphical user interface module” refers a module that provides a visual interface that allows users to interact with electronic devices, software applications, and operating systems through graphical elements such as icons, buttons, menus, and windows.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

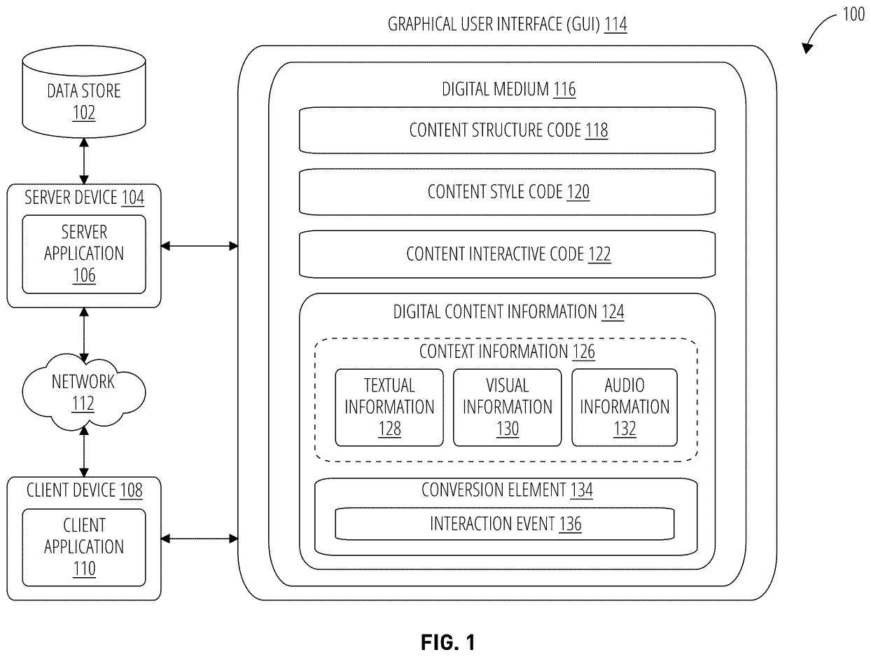

FIG. 1 illustrates an embodiment of a system 100. The system 100 is suitable for implementing one or more embodiments as described herein. In one embodiment, for example, the system 100 is an example of an architecture or framework for an online computer and communications system designed to serve digital content information to an electronic device associated with a user. Embodiments are not limited to this example.

In general, the system 100 includes a variety of servers, sub-systems, programs, modules, logs, and data stores. In particular embodiments, the system 100 includes one or more of the following: a web server, action logger, application programming interface (API)-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The system 100 also includes suitable components such as network interfaces, security mechanisms, load balancers, failover servers, management-and-network-operations consoles, privacy software, and other suitable components, or any suitable combination thereof.

As depicted in FIG. 1, the system 100 comprises a server device 104 communicating with a client device 108 over a network 112. In operation, a user interacts with a client application 110 of the client device 108 to access applications and services provided by a server application 106 of the server device 104. The server application 106 offers a number of network services for the system 100, such as generating and presenting a GUI 114 with a digital medium 116, such as a web page of a website. The server device 104 has access to one or more data stores 102. The data stores 102 store information for the server device 104, such as entity data, entity activity data, content items, digital content information, multimedia information, and so forth.

The system 100 comprises a server device 104. In particular embodiments, a server device 104 is an electronic device including hardware, software, or embedded logic components or a combination of two or more such components and capable of carrying out the appropriate functionalities implemented or supported by a server device 104. The server device 104 comprises a unitary server or a distributed server spanning multiple computers or multiple data centers. The server device 104 comprises one or more physical servers or virtual servers hosting one or more networking applications. As an example, and not by way of limitation, a server device 104 comprises part of a larger server system comprising multiple server devices organized as a data center, an edge computing center, or a cloud-computing center. This disclosure contemplates any suitable server device 104. A server device 104 is accessed by a network entity at a client device 108 via the network 112. A client device 108 enables its entity to communicate with other entities at the server device 102, such as via messaging applications.

In one embodiment, for example, the server device 104 is implemented as a web server. The web server is used for linking the server application 106 to one or more of the client devices 108 via a network 112. The web server includes a web hosting server or other website functionality for generating, optimizing, or presenting a web page of a website.

The server device 104 comprises a server application 106. In particular embodiments, the server application 106 is a web server to serve content information, such as content information, to the client application 110 of the client device 108. The server device 104 accepts a hypertext transfer protocol (HTTP) request and communicate to a client device 108 one or more HTML files responsive to the HTTP request. The server device 104 sends HTML files or XML files representing a webpage with content information for presentation via an electronic display of the client device 108 to a user.

The server device 102 comprises, or has access to, one or more data stores 102. A data store 102 is used to store various types of information for the server device 104 and/or the server application 106. In particular embodiments, the information stored in the data store 102 is organized according to specific data structures. In particular embodiments, the data store 102 is a relational, columnar, correlation, or other suitable database. Although this disclosure describes or illustrates particular types of databases, this disclosure contemplates any suitable types of databases. Particular embodiments provide interfaces that enable a client application 110 or a server device 104 to manage, retrieve, modify, add, or delete, the information stored in the data store 102.

In one embodiment, for example, the data store 102 stores content information for the server application 106. The content information comprises any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects that enhance a user's interactions with the server application 106.

The system 100 comprises a client device 108. In particular embodiments, a client device 108 is an electronic device including hardware, software, or embedded logic components or a combination of two or more such components and capable of carrying out the appropriate functionalities implemented or supported by a client device 108. As an example, and not by way of limitation, a client device 108 includes a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 108. A client device 108 enables a network user at a client device 108 to access a network 112. A client device 108 enables its entity to communicate with other entities at other client devices 108, such as via messaging application.

The system 100 comprises a client application 110. In particular embodiments, a client device 108 includes a client application 110, which is a web browser, and has one or more add-ons, plug-ins, or other extensions. An entity at a client device 108 enters a Uniform Resource Locator (URL) or other address directing a web browser to a particular server device 104 such as a server or server data center for an online system, and the web browser generates a Hyper Text Transfer Protocol (HTTP) request and communicate the HTTP request to the server device 104. The server device 104 accepts the HTTP request and communicate to a client device 108 one or more Hyper Text Markup Language (HTML) files responsive to the HTTP request. The client device 108 renders a web interface (e.g. a webpage) based on the HTML files from the server for presentation via an electronic display of the client device 108 to the entity. This disclosure contemplates any suitable source files. As an example, and not by way of limitation, a web interface is rendered from HTML files, Extensible Hyper Text Markup Language (XHTML) files, or Extensible Markup Language (XML) files, according to particular needs. Such interfaces also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser uses to render the web interface) and vice versa, where appropriate.

In particular embodiments, the client application 110 is an application operable to provide various computing functionalities, services, and/or resources, and to send data to and receive data from the other entities of the network 112, such as the server device 104. For example, the client application 110 is a client connection network application tightly integrated with the server application 106 of the server device 104, a messaging application for messaging with entities of a messaging network or system, a web browser application, an internet searching application, and so forth.

In particular embodiments, the client application 110 is storable in a memory and executable by a processor circuitry of the client device 108 to render user interfaces, receive user input, send data to and receive data from the server application 106 of the server device 104. The client application 110 generates and presents user interfaces to a user via an electronic display of the client device 108. For example, the client application 110 generates and presents a GUI 114 based at least in part on information received from the server device 104, the server application 106, and/or another device or system (e.g., a third party server) via the network 112.

In some embodiments, the server application 106 and/or the client application 110 and/or an operating system of the client device 108 generates a GUI 114 on an electronic display of the client device 108. The client application 110 receives various elements or components of a web page of a website. For example, the client application 110 receives a digital medium 116 that includes content structure code 118, content style code 120, and content interactive code 122.

The digital medium 116 includes content structure code 118. The content structure code 118 comprise code written in a standard language used to create and structure content on the web. It provides the fundamental building blocks for a webpage by defining elements such as headings, paragraphs, links, images, and lists through the use of tags. These tags tell web browsers how to display text and multimedia content, forming the backbone of a website's layout and structure. Examples of content structure code 118 includes HTML code, XML code, XHTML code, and the like.

The digital medium 116 includes content style code 120. The content style code 120 comprise code in a standard language used to describe the visual presentation of a web page written in the content structure code 118, such as HTML or XML. It enables developers to separate content from design, allowing them to specify styles such as fonts, colors, layouts, and spacing for elements on a page. An example of content style code 120 includes CSS. CSS controls a look and feel of a website, ensuring consistency across multiple pages, and make design adjustments more efficiently by altering the CSS file rather than modifying individual HTML elements. This separation also enhances accessibility and performance, as browsers can cache CSS files to improve load times and reduce server requests.

The digital medium 116 includes content interactive code 122. The content interactive code 122 is a high-level programming language primarily used to create interactive and dynamic features on websites. It allows developers to build complex functionalities by manipulating HTML and CSS, handling events, making asynchronous network requests, and updating content in real time without needing to reload the page. The content interactive code 122 powers everything from simple animations and form validations to sophisticated single-page applications. Examples of content interactive code 122 includes JAVASCRIPT, JAVA, MICROSOFT SILVERLIGHT, combinations of markup language and scripts such as Asynchronous JAVASCRIPT (AJAX), and XML), and the like.

The digital medium 116 further includes digital content information 124 rendered by the content structure code 118, content style code 120, and/or content interactive code 122. The digital content information 124 comprises different types of information, such as one or more conversion elements 134 and context information 126 for the conversion elements 134. Examples of context information 126 include textual information 128, visual information 130, audio information 132, and other multimedia information. In some embodiments, context information 126 for a conversion element 134 includes any type of content information within a defined distance of a position for the conversion element 134 in the digital medium 116. In some embodiments, interaction event 136 for a conversion element 134 is all the content information for the entire web page. Embodiments are not limited in this context.

A conversion element 134 is a component on a web page that is strategically designed to prompt visitors to take a desired action, like making a purchase, subscribing to a service, or filling out a contact form. In some embodiments, a conversion element is an interactive element on a graphical user interface to collect data from users. Examples of an interactive element includes an input field, checkboxes, radio buttons, submit buttons, hyperlinks, forms, call-to-action button, promotional banner, and the like. These elements are key to converting casual browsers into engaged leads or customers by clearly communicating benefits and guiding users through the conversion funnel. Effective conversion elements are visually prominent, feature concise messaging, and are integrated seamlessly into the overall design, ensuring that the user experience is smooth and compelling enough to drive the intended behavior. When activated in response to a selection by an input device, the conversion element 134 generates an interaction event 136. The interaction event 136 is logged by the action logger and stored in the data store 102. The interaction event 136 also triggers a call handing procedure to perform an action by the server application 106.

The system 100 comprises a network 112. This disclosure contemplates any suitable network 106. As an example and not by way of limitation, one or more portions of a network 106 includes an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 112 comprises multiple networks 112.

In operation, an entity 108 interacts with a client application 110 of the client device 108 to access applications and services provided by the server application 106 of the server device 104 via one or more links of the network 112. The links connect each client device 108 to the server device 104 via the network 112. This disclosure contemplates any suitable link. In particular embodiments, one or more links include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily operate at the same throughout. In some embodiments, one or more first links differ in one or more respects from one or more second links.

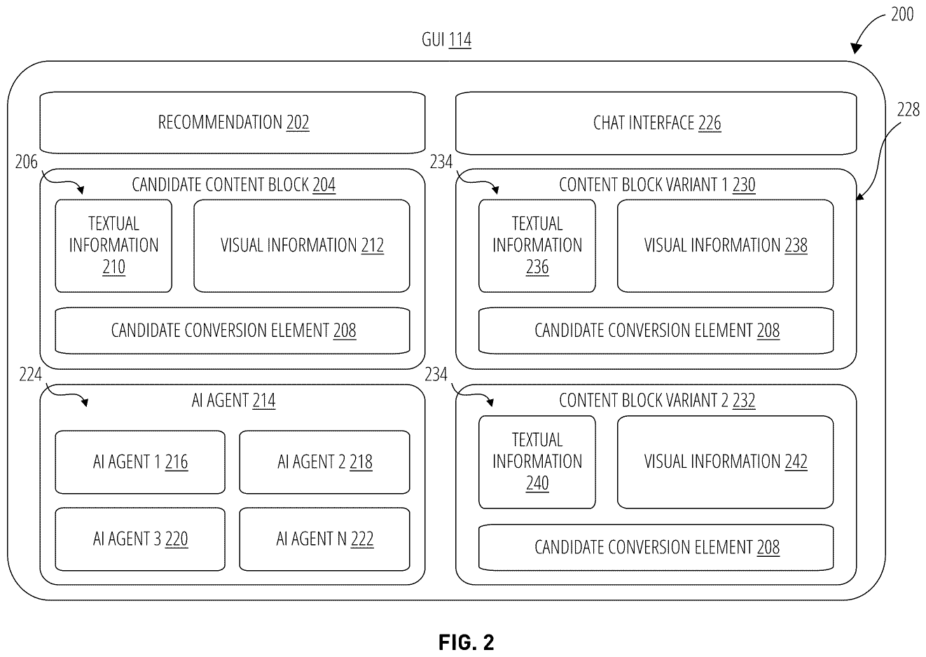

FIG. 2 illustrates a logic diagram 200. The logic diagram 200 provides an example of components for a GUI 114. The GUI 114 depicts parts of a web page from a website rendered on the digital medium 116. Embodiments are not limited to this example.

As previously described, designing content information for a web page of a website remains a technical problem. A web page is typically generated through a collaborative process that starts with planning and design, where the layout, branding, and functionality are defined to meet business goals and user needs. Designers create mockups and wireframes, which are then translated into code by developers using hypertext markup language (HTML) for structure, cascading style sheets (CSS) for styling, and JavaScript for interactivity. Content is integrated, often through a Content Management System (CMS), to ensure the page is dynamic and easily updatable. Once developed, the site undergoes rigorous testing across different devices and browsers to ensure compatibility and optimal performance before being deployed to a live server, making it accessible to users worldwide. This process is often time-consuming and requires a significant amount of manual effort by a design team.

Embodiments provide a technical solution to this technical problem. For example, embodiments implement various automation techniques to automatically generate or optimize the design, development, and deployment of a web page. Some embodiments use an AI framework to optimize a web page that integrates generative AI (GAI), real use monitoring (RUM) analytics, AI agents to generate variants of context information for a web page, and an experimental sub-system to test the variants. For example, the GAI assists in auto-detection of conversion elements and associated context information of a web page. The RUM analytics assist in selecting candidate conversion elements suitable for optimization given a defined metric (e.g., click-through rate). The RUM analytics also assist in selecting AI agents suitable for providing insights for the candidate conversion elements. The selected AI agents generate variants of the context information for the candidate conversion elements to increase the given metric. An experimental sub-system performs A/B testing on the variants, collects real-time measurements, and selects a variant suitable for deployment by the web page. A production system then deploys the selected variant for the web page for presentation to an audience of members.

As depicted in logic diagram 200, the GUI 114 presents a recommendation 202 and a candidate content block 204. The recommendation 202 comprises multimedia information, such as text information, prompting a user to optimize digital content information 124 for the digital medium 116. For example, a recommendation 202 is a prompt stating “Understand why your content might not be engaging enough by asking persona-driven agents.” The candidate content block 204 is a portion of the digital content information 124 suitable for optimization. The candidate content block 204 includes a candidate conversion element 208. The candidate content block 204 further includes context information 206 for the candidate conversion element 208, such as textual information 210 and/or visual information 212. The context information 206 is content information that is within a defined distance of a position of the candidate conversion element 208. For example, if the candidate conversion element 208 is at position A at the end of the web page, the context information 206 is any content information from position A to a position B on the web page. Position B is in a top section of the web page, a middle section of the web page, and so forth. In another example, the context information 206 is all the content information for an the web page that includes the candidate conversion element 208. Embodiments are not limited in this context.

The GUI 114 further presents a set of AI agents 214. The set of AI agents 214 includes an AI agent 1 216, an AI agent 2 218, an AI agent 3 220, and an AI agent N 222, where N represents any positive integer. An AI agent 214 is a software program that employs AI techniques to perform tasks that typically require human-like intelligence. The AI agent 214 takes many forms, from simple chatbots to complex autonomous systems that interact with their environment and make decisions in real-time. They can be trained using various machine learning techniques, including supervised, unsupervised, and reinforcement learning. The AI agent 214 is programmed to perform specific tasks or learn from their experiences to improve performance over time.

In some embodiments, an AI agent 214 is an LLM-based agent. An LLM-based agent employs LLM techniques due to its high efficiency and flexibility in various tasks and domains. For example, the LLM techniques include task instructions from a human user or prompt template, a designed prompt, a tool set, an LLM, an intermediate output, and a final output. A task instruction is an explicit input to the LLM. A designed prompt includes additional input for the LLM, such as system instructions, tool descriptions, few-shot demonstrations, chat history, or even error output. A tool set is a set of external resources, services, APIs, or sub-systems that an AI agent 214 can use to complete a task. An LLM interprets the task instructions and prompts, interacts with the toolset, and generates intermediate outputs and final answers. Examples of LLM include ChatGPT, GPT-4, and others. An intermediate output represents an output of the LLM that merits further review and feedback to refine the output. A final output represents the output AI agent 214 provides to the user after all processes (e.g., task planning, tool usage, error feedback, etc.) have been completed.

In some embodiments, for example, an AI agent 214 is designed to operate with a defined persona referred to as an “audience persona.” An audience persona 224 is a personality profile to guide its interactions with users and/or digital content. A personality profile defines a set of characteristics, traits, preferences, behaviors, attributes, tones, styles, perspectives, tones, properties, and the like. This crafted identity helps ensure that the AI agent 214 communicates in a consistent, relatable manner, aligning with user expectations, audience expectations, and the intended brand image. The GUI 114 presents one or more AI agents 214 with audience personas simulating one or more individuals from various audience segments intended for a web page. By incorporating attributes such as friendliness, professionalism, humor, or formality, the audience persona 224 not only enhances user engagement but also influences how effectively the AI agent 214 fulfills its role in providing variants and feedback concerning context information 126 for conversion elements 134 of a web page. For example, assume the web page is for a travel website. Examples of AI agents 214 with different audience personas 224 includes a young professional woman working at a start-up renewable energy company, a male parent working as a middle school teacher planning a trip for her family, a female travel influencer for urban destinations, a male budget conscious traveler exploring the world on a limited budget, and so forth. Embodiments are not limited to these examples.

The AI agents 214 with different audience personas 224 assist in generating variants of the context information 206 for the candidate conversion element 208 of the candidate content block 204 to increase the given metric. For example, assume a web page is designed for a travel website and it has a candidate conversion element 208 with a hyperlink to an advertisement for a travel company offering a travel service. The candidate conversion element 208 includes context information 206, such as textual information 210 describing a travel destination and visual information 212 such as an image of the destination. A human user engages with the AI agents 214 with the audience personas 224 in a structured multi-agent dialogue, such as a website designer, to collaborate on modifying content information for a web page in a chat-like manner via a GUI chat interface 226. The audience personas 224 provide qualitative feedback on how the context information 206 surrounding the candidate conversion element 208 can be improved to better align with their expectations and motivations. The synthesized feedback is then used to iteratively generate optimized multimedia content variations, such as content block variants 228, that maximize engagement across diverse audience segments. The content block variants 228 includes a content block variant 1 230 comprising the candidate conversion element 208 and a context information variant 234 comprising textual information 236 and/or visual information 238. The content block variants 228 also includes content block variant 2 232 comprising the candidate conversion element 208 and a context information variant 234 comprising textual information 240 and/or visual information 242 The textual information 236 and visual information 238 of the context information variant 234 for the content block variant 1 230, and the textual information 240 and/or the visual information 242 of the context information variant 234 for the content block variant 2 232, are different from the textual information 210 and the visual information 212 of the context information 206 for the candidate content block 204. The human user can then select from among the multiple content block variants 228 for testing with a human audience.

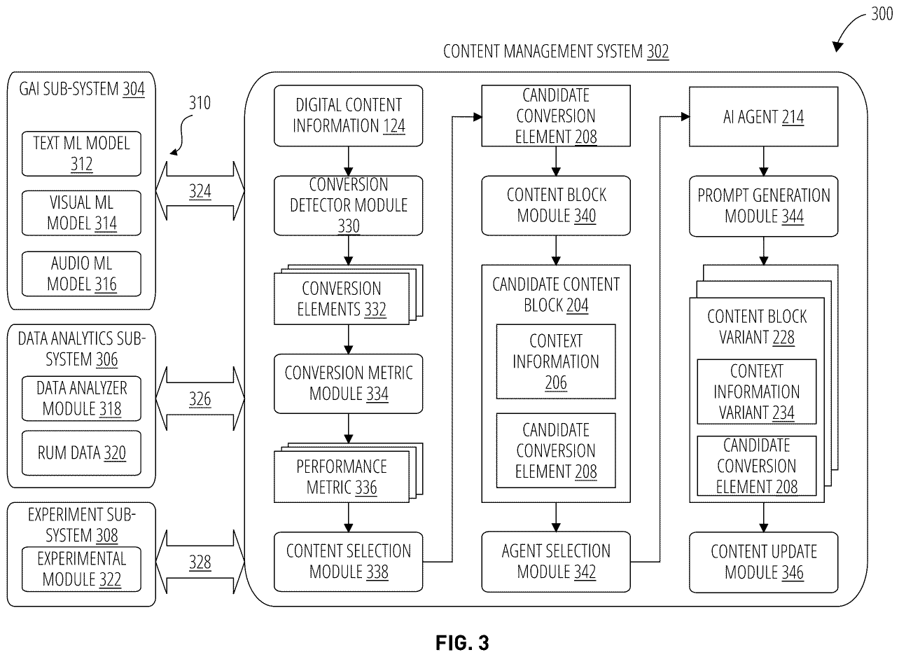

FIG. 3 illustrates a logic diagram 300. The logic diagram 300 illustrates an AI framework or architecture with different modules, components, devices, sub-systems, and systems for optimizing digital content information 124 for the digital medium 116 in accordance with embodiments herein. The AI framework executes an agentic workflow to optimize digital content information 124 for digital medium 116, such as a web page of a website. In some embodiments, the AI framework is implemented by a combination of hardware and software, such as circuitry (e.g., a processor) coupled to memory (e.g., non-transitory computer-readable media) storing code instructions that when executed by the circuitry to perform certain actions and functions. In some embodiments, the AI framework is implemented by just hardware, such as an application specific integrated circuit (ASIC) or field programmable gate array (FPGA). Embodiments are not limited to these examples.

The embodiments as described herein represent a major innovation in an agentic workflow that marketers and web writers are following to improve user engagement of the content of their pages. The innovative component is represented by how AI-simulated marketing personas are interacting in a chat-like context, expressing their opinions and formulating coherent feedback to improve the content of pages to boost user engagement, leading to more awareness and activity on marketing conversion elements. Moreover, it provides a way to deal with possible user uncertainties affecting content generated by AI, by allowing users to interact with each marketing personas in a chat-like way, influencing the quality of produced results to maximize their quality and accuracy.

As previously described, embodiments implement various automation techniques to automatically generate or optimize the design, development, and deployment of a web page. Some embodiments use an AI framework to optimize a web page that integrates generative AI (GAI), real use monitoring (RUM) analytics, AI agents to generate variants of context information for a web page, and an experimental sub-system to test the variants. For example, the GAI is an LLM that assists in auto-detection of conversion elements and associated context information of a web page. The RUM analytics assist in selecting candidate conversion elements suitable for optimization given a defined metric (e.g., click-through rate). The RUM analytics also assist in selecting AI agents suitable for providing insights for the candidate conversion elements. The selected AI agents generate variants of the context information for the candidate conversion elements to increase the given metric. An experimental sub-system performs A/B testing on the variants, collects real-time measurements, and selects a variant suitable for deployment by the web page. A production system then deploys the selected variant for the web page for presentation to an audience of users.

FIG. 3 illustrates an example of an AI framework designed to optimize digital content information 124 rendered on a digital medium 116 such as a web page of a website. As depicted in logic diagram 300, a content management system 302 implements a GAI sub-system 304 to assist in identifying conversion elements 134 of a digital medium 116, select a candidate conversion element 208 suitable for optimization, retrieve context information 206 for the candidate conversion element 208, and generate one or more context information variants 234 to increase a performance metric 336 for the candidate conversion element 208. Examples of context information variants 234 includes modifications to a page layout (e.g., HTML code, CSS code, etc.), multimedia content information (e.g., text, audio, image, video, animation, etc.) for context information variants 234, changes to the candidate conversion element 208 (e.g., switching from a button to link), suggesting different user demographics for the candidate conversion element 208, and the like. A design goal of a given context information variant 234 is to drive a defined action as measured by a given performance metric 336, such as causing a user to increase interaction with the candidate conversion element 208 as measured by a click-through-rate (CTR).

Specifically, the content management system 302 implements or communicates with a GAI sub-system 304 using one or more ML models 310. Examples of ML models 310 include artificial neural networks (ANN), deep neural networks (DNN), transformers, generative adversarial networks (GAN), and the like. Different ML models 310 are implemented to generate different types of context information for a conversion element. For example, the GAI sub-system 304 implements a text ML model 312 to generate textual information using natural language expressions, an image ML model 310 to generate visual information, an audio ML model 316 to generate audio information, and so forth. The GAI sub-system 304 implements other ML models 310 for other modalities, such as a video ML model to generate video information, an animation-based ML model to generate animation information, a multimodal ML model to generate multimedia information, and so forth.

The GAI sub-system 304 uses different ML models 310 for different tasks. For example, a text ML model 312 such as a large language model (LLM) is used to generate textual information using natural language expressions for variants of original textual information in the contextual information of a conversion element. An LLM is designed to understand and generate human-like content by leveraging deep learning techniques on extensive datasets. These models, built on architectures like transformers, are trained on vast amounts of textual data to capture linguistic patterns, semantic relationships, and contextual nuances. As a result, LLMs can perform a variety of tasks such as answering questions, translating languages, summarizing content, and even engaging in coherent conversations. An LLM is used to interact with a human user in a chat-like manner to receive instructions and feedback from the human user. The LLM is also used to generate textual information for responses to the human user and variants for the original textual information of a conversion element. In another example, a visual ML model 314 such as DALL-E, Stable Diffusion, or Midjourney is used to generate visual information for variants of original visual information in the contextual information of a conversion element. These are merely some examples. Different ML models 310 for different modalities are combined to generate multimedia variants of context information for a conversion element, including textual information, visual information, audio information, video information, animation information, and the like. In some cases, different modalities are generated using a multimodal ML model. Embodiments are not limited to a particular ML model or a particular modality for the ML model.

In some embodiments, the content management system 302 implements or communicates with a data analytics sub-system 306 to collect and use analytics, such as RUM data 320, to assist in selecting candidate conversion elements 208 suitable for optimization given a performance metric 336 (e.g., click-through rate). RUM data 320 in the context of machine learning involves collecting and analyzing performance data from real users interacting with ML-powered applications in their natural environments. This approach monitors key metrics such as response times, error rates, and user engagement, providing insights into how the deployed models perform under actual usage conditions. By capturing this real-world feedback, developers and data scientists can identify issues like model drift, latency problems, or unexpected biases that might not surface during controlled testing. Ultimately, RUM data 320 helps ensure that machine learning systems deliver a reliable, optimal user experience and supports ongoing improvements and maintenance in production. The data analytics sub-system 306 receives the RUM data 320 from various data sources designed to collect the RUM data 320, such as tracking and analyzing performance metrics 336 as experienced by actual users. Examples of performance metrics 336 include measuring page load times, monitoring error rates, collecting code exceptions (e.g., JavaScript exceptions), and user engagement metrics. Examples of user engagement metrics include click-through-rates (CTR), conversion rates (CVR), dwell times, bounce rates, conversion events, impressions, and so forth. The content management system 302 analyzes the performance metrics 336 using the data analyzer module 318, particularly the user engagement metrics, to perform tasks such as identifying conversion elements candidate conversion element 208 from a web page that are suitable for optimization. For example, the content management system 302 selects a set of conversion elements 134 from a web page based on RUM data 320. The content management system 302 also selects a subset of conversion elements from the set of conversion elements based on RUM data 320. For example, the RUM data 320 selects a subset of conversion elements associated with a performance metric 336 such as a lower CTR score, as compared to a defined threshold value for a CTR score, as indicated by the RUM data 320. The subset of conversion elements become candidate conversion elements 208 for further inspection and analysis.

In some embodiments, the content management system 302 uses the data analytics sub-system 306 to assist in selecting AI agents 214 suitable for providing insights for candidate conversion elements 208. An AI agent 214 is an autonomous system that perceives its environment, processes information using algorithms, and takes actions to achieve specific goals. It interacts with its surroundings through sensors and actuators, employing techniques from machine learning, decision theory, and sometimes reinforcement learning to adapt and optimize its behavior over time. AI agents 214 can operate in various domains where they continuously analyze data, make decisions, and learn from feedback to improve performance. Specifically, the content management system 302 selects one or more AI agents 214 based, at least in part, on activity data of users. The AI agents 214 simulate actions or feedback of an individual or group of individuals (e.g., human beings) from various target audience segments of a web page. For example, assume a web page advertises an online learning course for working professionals in the aerospace industry and has a target audience segment comprising individuals between the ages of 25-45 with an undergraduate degree in aerospace engineering. The content management system 302 selects an AI agent 214 for simulating a 30 year old female with an undergraduate degree in aerospace engineering working at a full-time job in a given geographic area.

In some embodiments, an AI agent 214 is designed to operate with a defined persona referred to as an “audience persona.” An audience persona 224 represents a human-like personality for an AI agent 214 to assist in guiding its interactions with human users and/or digital content information 124. An audience persona 224 for an AI agent 214 is implemented by generating and storing a personality profile for each AI agent. A personality profile defines a given audience persona 224 by storing a set of parameters representing human-like characteristics, traits, preferences, behaviors, attributes, tones, styles, perspectives, properties, and the like. This crafted identity helps ensure that the AI agent 214 communicates in a consistent, relatable manner, aligning with user expectations, audience expectations, and the intended brand image.

In some embodiments, the content management system 302 selects one or more AI agents 214 with audience personas 224 comprising personality profiles designed for simulating one or more individuals from various audience segments intended for viewing a web page and interacting with a conversion element. As a result, an AI agent 214 with a given audience persona 224 interacts with a human designer in a manner that is similar to an actual human from the intended audience. This includes providing responses similar to a human personality, analyzing information from the perspective of a human personality, generating content as a human personality, and other actions. By incorporating human-like attributes such as friendliness, professionalism, humor, or formality, the audience persona not only enhances user engagement but also influences how effectively the agent fulfills its role in providing variants and feedback concerning context information for conversion elements of a web page.

In some embodiments, the AI agents 214 with the audience personas 224 generate context information variants 234 for the candidate conversion elements 208 to increase a given performance metric 336. For example, assume a web page is designed for a travel website and it has a conversion element with a hyperlink to an advertisement for a travel company offering a travel service. The candidate conversion element 208 is positioned on a web page (e.g., top, bottom, left, right, middle, etc.) and is surrounded by digital content information that provides context for the conversion element (e.g., above, below, beside, in-line, etc.). In this example, assume context information 206 is within a defined distance of the position of the candidate conversion element 208 and it includes textual information 210 describing a travel destination and visual information 212 such as an image of the destination positioned above the candidate conversion element 208 on the web page. The content management system 302 uses RUM data 320 to suggest or select AI agents 214 provisioned with audience personas 224 such as a young professional working at a start-up renewable energy company, a parent working as a schoolteacher planning a trip for her family, a travel influencer for urban destinations, a budget conscious traveler, and so forth. The audience personas 224 engage in a structured multi-agent dialogue with a human user, such as a website designer, to collaborate on modifying content information for a web page in a chat-like manner via a GUI chat interface 226. The audience personas 224 provide qualitative feedback on how the context information 206 surrounding the candidate conversion element 208 can be improved to better align with their expectations and motivations. The synthesized feedback is then used to iteratively generate optimized multimedia content variations that maximize engagement across diverse audience segments.

In some embodiments, an AI agent 214 is implemented as an LLM-based agent. For example, the content management system 302 generates a prompt for the LLM using prompt engineering techniques, where the prompt includes a personality profile of an audience persona 224, digital content information 124 from the web page, context information 206 from the web page, instructions to generate responses and variants using the audience persona, one-shot or few-shot examples, website descriptions, audience descriptions, and other types of information. In some cases, the content management system 302 generates the prompt using one or more prompt templates to accelerate prompt generation. The LLM receives the prompt as input, and it operates as an AI agent 214 imbued with characteristics of the personality profile to generate a response consistent with the audience persona 224. For example, if the audience persona 224 is a young professional then the LLM will generate a response that simulates a response using a tone, language, humor, insights, and other personality traits of a young professional. The response includes a variant of the content information, such as context information variants 234 for a candidate conversion element 208, which is then presented on a GUI 114 of an electronic display of an electronic device such as client device 108 for review by a human user. The human user can then select one or more context information variants 234 for experimental testing.

An experimental GAI sub-system 304 performs experimental testing on the context information variants 234, collects real-time measurements such as RUM data 320, and selects a context information variant 234 suitable for deployment by the web page. In some embodiments, the experimental GAI sub-system 304 uses an experimental module 322 to implement A/B testing to experiment on variants of digital content information 124, including the context information variants 234 for a candidate conversion element 208, for a web page. A/B testing is an experimental approach where different versions of a page are shown to separate groups of users to determine which design or content performs better against specific performance metrics, such as conversion rates or user engagement. By randomly assigning visitors to different variants, entities (e.g., businesses, website designers, etc.) collect quantitative data that reveal how changes in design, layout, or copy influence user behavior. The results are then analyzed using statistical methods to confirm whether observed differences are significant, enabling data-driven decisions to optimize and deploy the web page for improved performance and user experience.

For example, once a human user selects multiple context information variants 234 for testing, the variants are passed to the experimental GAI sub-system 304 for A/B testing. Imagine a travel website aiming to boost the number of bookings through a candidate conversion element 208 such as a prominent call-to-action (CTA) button. In version A of the web page, the CTA button is placed at the top of the page with a bold, contrasting color and a straightforward message like “Book Your Dream Vacation Today,” paired with a high-quality image of a relaxing beach resort. In version B, the page features a full-screen video background showcasing popular destinations with the CTA overlay reading “Discover Your Next Adventure,” enhanced by subtle animations to draw attention. Visitors are randomly directed to one of the two versions, and metrics such as click-through rates on the CTA, time spent on the page, and completed bookings are monitored. By comparing the performance data from both variants, the experimental sub-system can determine which design more effectively drives conversions for the travel website, thereby allowing for a data-driven decision to adopt the more successful approach.

Once the experimental GAI sub-system 304 selects a context information variant 234 based on the RUM data 320, the experimental GAI sub-system 304 passes the context information variant 234 to a production server for a massive cloud-based online system, such as system 100. The production server then deploys the selected variant as a current optimization of the web page for presentation to its intended audience as part of a website. The optimization process is performed on a continuous, periodic, or a periodic basis to ensure that context information for conversion elements of a web page of a website is continuously improved upon to drive members of an audience segment to interact with the conversion elements to improve one or more performance metrics.

By way of example, as shown in the AI framework of logic diagram 300, a content management system 302 implements circuitry executing logic and/or instructions for receiving, by a conversion detector module 330, digital content information 124 from the digital medium 116 as described with reference to FIG. 1. In some embodiments, the digital content information 124 is rendered on the digital medium 116 using content structure code 118, content style code 120, or content interactive code 122 of a web page. The digital content information 124 includes a conversion element 134 and context information 126 for the conversion element 134. The context information 126 includes textual information 128, visual information 130, or audio information 132. The conversion element 134, when activated through selection by an input device, generates an interaction event 136. The interaction event 136 represents user activity interacting with the conversion element 134.

The content management system 302 uses the circuitry for identifying, by the conversion detector module 330, a set of conversion elements 332 encoded into digital content information 124 using an ML model 310 of the GAI sub-system 304. The conversion elements 332 are similar to the conversion element 134 of FIG. 1. One objective of the content management system 302 is to increase engagement rates with the conversion elements 332 by optimizing context information 206.

In some embodiments, the conversion detector module 330 performs pre-processing operations on the set of conversion elements 332. For example, the conversion detector module 330 detects the conversion elements 332. The conversion detector module 330 filters, non-conversion elements from the set of conversion elements 332 using the ML model 310. The conversion detector module 330 identifies inoperable conversion elements from the set of conversion elements 332. An example of an inoperable conversion element is an invalid CSS selector. The conversion detector module 330 converts the inoperable conversion elements to operable conversion elements. For example, the conversion detector module 330 sends a prompt to the ML model 310 with a request to repair the inoperable conversion element. The conversion detector module 330 outputs a final set of conversion elements 332 to the conversion metric module 334.

The content management system 302 uses the circuitry for generating, by a conversion metric module 334, a set of performance metrics 336 for the set of conversion elements 332 using RUM data 320. For example, the conversion metric module 334 receives the conversion elements 332 from the conversion detector module 330. The conversion metric module 334 generates performance metrics 336 for the conversion elements 332. For example, the conversion metric module 334 generates the performance metrics 336 using RUM data 320 from the data analytics sub-system 306. Examples of performance metrics 336 comprise a click-through-rate (CTR) metric, a conversion rate (CVR) metric, a dwell rate metric, or a bounce rate metric.

The content management system 302 uses the circuitry for selecting, by a content selection module 338, a candidate conversion element 208 from the set of conversion elements 332 based on the set of performance metrics 336. The candidate conversion element 208 comprises a GUI element of the GUI 114 that when activated by an input device generates an interaction event 136 for the web page. To perform a selection, the content management system 302 uses the circuitry for ranking, by the content selection module 338, the set of conversion elements 332 based on the performance metrics 336 to form a rank ordered list of conversion elements 332. The content selection module 338 selects the candidate conversion element 208 from the ranked set of candidate conversion elements 208 corresponding to a rank value that is above a defined threshold value (e.g., a top ranked element, a k percentage or k number of ranked elements, etc.). The content selection module 338 outputs the selected candidate conversion element 208 to the content block module 340.

The content management system 302 uses the circuitry for determining, by a content block module 340, a candidate content block 204 from the digital content information 124. For example, the candidate content block 204 includes the candidate conversion element 208 and context information 206 associated with the candidate conversion element 208. For example, the context information 206 comprises content information within a defined distance of a position of the candidate conversion element 208 on the web page as measured by a Cartesian coordinate system. In some embodiments, the content management system 302 uses the circuitry for determining, by the content block module 340, a position for the candidate conversion element 208 in the digital content information 124. The content block module 340 identifies context information 206 for the candidate conversion element 208 in the digital content information 124 within a defined distance of the position. The content block module 340 generates a candidate content block 204 from the digital content information 124 that includes the candidate conversion element 208 and the context information 206 for the candidate conversion element 208. In some cases, the context information 206 comprises all the digital content information 124 exclusive of the candidate conversion element 208.

The content management system 302 uses the circuitry for selecting, by an agent selection module 342, an AI agent 214 from a set of AI agents 214. Each AI agent 214 in the set of AI agents 214 includes a different audience persona 224. The agent selection module 342 selects the AI agent 214 based on a number of factors. For example, the agent selection module 342 selects the AI agent 214 based on the candidate content block 204, the context information 206, the candidate conversion element 208, RUM data 320 for users from the data analytics sub-system 306, a website description, pre-generated AI agents 214 from another software application, a target audience segment for a website, demographic information, geographic information, a recommendation by the ML model 310, and so forth.

The content management system 302 uses the circuitry for generating, by a prompt generation module 344, a prompt for the selected AI agent 214. For example, the prompt includes the candidate content block 204 and instructions to generate one or more content block variants 228. A content block variant 228 includes the candidate conversion element 208 and a context information variant 234 of the context information 206 associated with the candidate conversion element 208. In some embodiments, the prompt generation module 344 generates a prompt that includes instructions for the AI agent 214 to generate the content block variant 228 using an audience persona 224 defined by a personality profile for an audience member of a target audience segment for the digital content information 124.

The content management system 302 uses the circuitry for receiving, from the AI agent 214, a set of one or more content block variants 228 that includes the candidate conversion element 208. In some embodiments, the AI agent 214 is an LLM-based agent implemented by an ML model 310 designed to generate textual information 128, visual information 130, audio information 132, or a combination thereof.

The content management system 302 uses the circuitry for performing, by an experimental module 322 of an experiment sub-system 308, experiments for the content block variants 228. The experimental module 322 implements an A/B experiment using a testing algorithm. During or after testing, the conversion metric module 334 generates performance metrics 336 for the content block variants 228 based on results from the experiments. The experimental module 322 selects a content block variant 228 from the set of content block variants 228 based on the set of performance metrics 336. The experimental module 322 outputs the selected content block variant 228 to the content update module 346.

The content management system 302 uses the circuitry for updating, by the content update module 346, the digital content information 124 to include the content block variant 228 in replacement of the candidate content block 204 for the digital content information 124. The content block variant 228 includes the context information variant 234 for the candidate conversion element 208.

The content management system 302 uses the circuitry for presenting, by a content update module 346, the content block variant 228 on a GUI 114. Once the content update module 346 updates the digital content information 124 to include the content block variant 228, it stores the modified digital content information 124 in the data store 102. The server application 106 then serves the modified digital content information 124 in the digital medium 116 of the GUI 114. This process repeats on a periodic, a periodic, on-demand, or continuous basis.

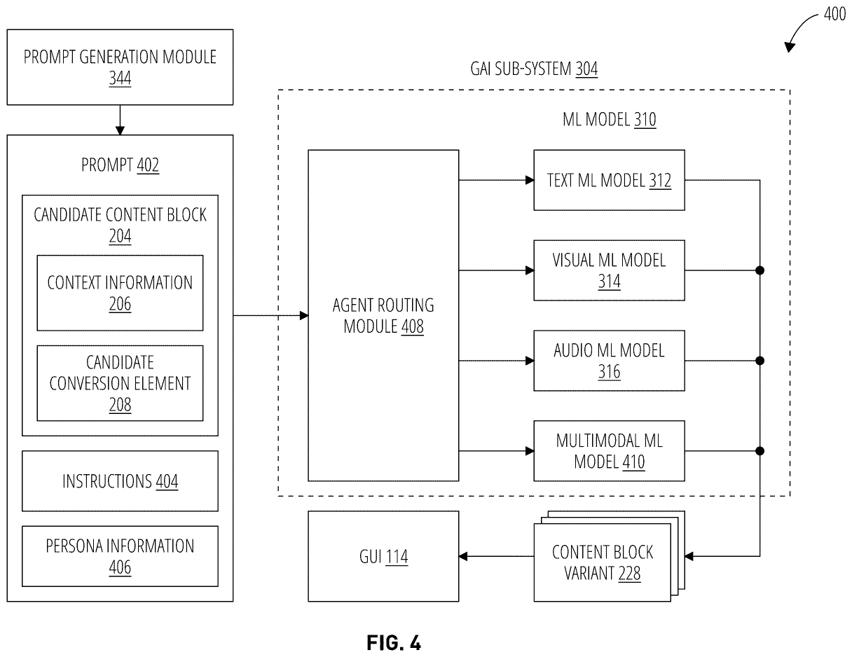

FIG. 4 illustrates a logic diagram 400. The logic diagram 400 is an example of the prompt generation module 344 of the content management system 302 interoperating with the GAI sub-system 304. Embodiments are not limited to this example.

As depicted in FIG. 4, the logic diagram 400 illustrates the prompt generation module 344 of the content management system 302 generating a prompt 402 for an AI agent 214. For example, the prompt 402 comprises the candidate content block 204 having the context information 206 and the candidate conversion element 208. The prompt 402 also includes a set of instructions 404 for the AI agent 214. The instructions 404 define a task for the candidate content block 204. For instance, the instructions 404 specifies a task of optimizing the context information 206 for the candidate conversion element 208. The instructions 404 also assigns persona information 406 for an audience persona 224 to the AI agent 214 to guide its response. For example, the instructions 404 state the AI agent 214 is to optimize the context information 206 for the candidate conversion element 208 from the perspective of an audience member for the web page or website from which the candidate content block 204 is derived, such as “You are a 30 year old wanderer curious about travel destinations.” The instructions 404 details task requirements and clearly states what is needed in the answer. For example, task requirements could be “Provide textual content and visual content that would be persuasive in choosing a travel destination and drive engagement to learn more or take action.” The instructions 404 add formatting and style constraints when appropriate, such as “Limit the textual content to a single paragraph written in a fun, engaging, and humorous style and an image that depicts the textual content.”

The prompt generation module 344 generates the prompt 402 and sends it to the GAI sub-system 304. The GAI sub-system 304 comprises an agent routing module 408 that receives and analyzes the prompt 402. The agent routing module 408 routes the prompt 402 to an ML model 310 based on its analysis. For example, the agent routing module 408 analyzes the prompt 402 and determines that the prompt 402 requests textual information. It therefore forwards the prompt 402 to the text ML model 312, such as an LLM, to generate textual information. The agent routing module 408 also determines that the prompt 402 requests visual information. It therefore forwards the prompt 402 to the visual ML model 314, such as Midjourney, to generate visual information. When the ML models 310 include a multimodal ML model 410, the agent routing module 408 forwards the prompt 402 to the multimodal ML model 410 to generate both textual information and visual information.

The ML model 310 receives the prompt 402, and it generates one or more content block variants 228. A content block variant 228 comprises context information variant 234 for the candidate conversion element 208. The content block variants 228 are stored in the data store 102, and the server device 104 presents the content block variants 228 on the GUI 114 for review by a human user, such as a web designer. The user selects the content block variants 228 for testing. The selected content block variants 228 are then forwarded to the experiment sub-system 308 for the experimental module 322 to perform A/B testing.

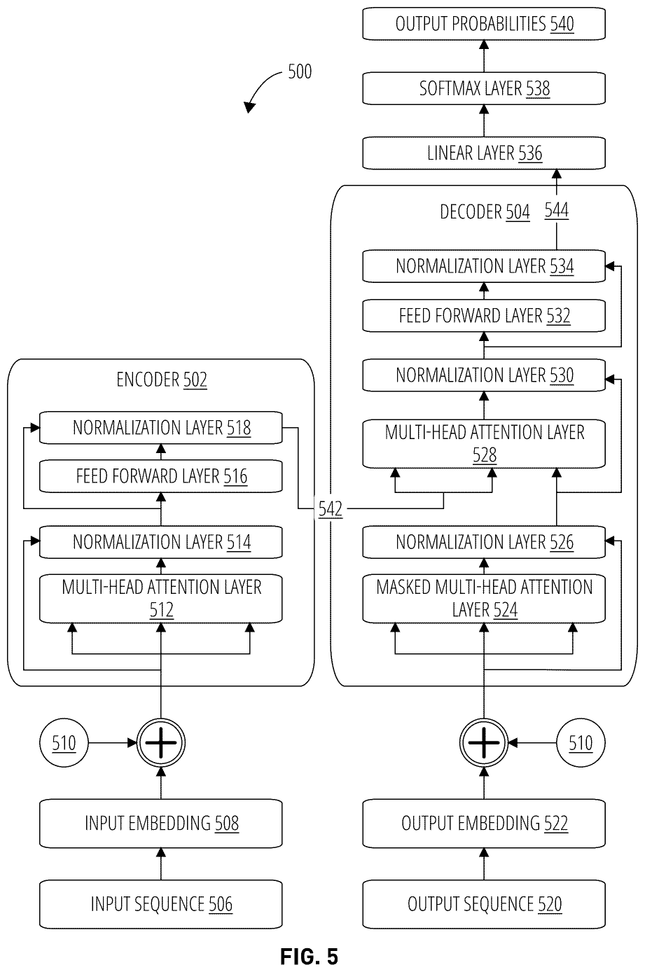

FIG. 5 illustrates a transformer model 500. The transformer model 500 is an example of a transformer architecture suitable for use by an ML model 310, such as the text ML model 312, of the GAI sub-system 304. In particular, the transformer model 500 is an example of a transformer architecture suitable for GPT, such as a version of ChatGPT, or a large language model (LLM). ChatGPT is trained on massive amounts of data, allowing it to generate text and respond to various prompts with human-like precision and accuracy. Embodiments are not limited to transformers.

As depicted in FIG. 5, the transformer model 500 comprises an encoder 502 and a decoder 504. The encoder 502 receives as input an input sequence 506, which is converted to an input embedding 508. A positional encoding 510 is added to the input embedding 508. The input embedding 508 with positional encoding 510 is input to the encoder 502. The encoder 502 comprises a multi-head attention layer 512, a normalization layer 514, a feed forward layer 516, and a normalization layer 518. The encoder 502 outputs an encoder output 542 to the decoder 504. The decoder 504 receives as input an output sequence 520, which is converted to an output embedding 522. A positional encoding 510 is added to the output embedding 522. The output embedding 522 with positional encoding 510 is input to the decoder 504. The decoder 504 comprises a masked multi-head attention layer 524, a normalization layer 526, a multi-head attention layer 528, a normalization layer 530, a feed forward layer 532, and a normalization layer 534.

Specifically, the encoder 502 is a neural sequence transduction model comprising an encoder 502 and a decoder 504. The encoder 502 receives an input sequence 506 and it translates the input sequence 506 into a lower-dimensional space. The encoder 502 maps an input sequence of symbol representations (x₁, . . . , xₙ) to a sequence of continuous representations z=(z₁, . . . , Zₙ). Given z, the decoder 504 then generates an output sequence (y₁, . . . , yₘ) of symbols one element at a time. At each step, the model is auto-regressive, consuming the previously generated symbols as additional input when generating the next. The decoder 504 translates the lower-dimensional data provided by the encoder 502 back to the original data format. Both the encoder 502 and the decoder 504 share three main types of layers, including a positional encoding layer, self-attention layer, and feedforward layer.

The encoder 502 transforms natural language input into numerical vectors. The encoder 502 receives an input sequence 506. The input sequence is a sequence of tokens (e.g., words or sub-words) that represent the text input. An input encoding layer of the encoder 502 converts the input sequence 506 into an input embedding 508. An input embedding 508 is a numerical representation of concepts converted to number sequences. The input embedding 508 is an NLP technique that represents words with vectors in such a way that once represented in a vectorial space, the mathematical distance between vectors is representative of the similarity among words they represent. For example, the content delivery application 120 incorporates input embeddings to personalize, recommend, and search content. The input embedding 508 comprises a matrix of vectors, where each vector represents a token in the sequence. The input embedding layer maps each token to a high-dimensional vector that captures the semantic meaning of the token.

Positional encoding 510 is a fixed, learned vector that represents a position of a word in the input sequence. It is added to the input embedding 508 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 508. The positional encoding is a vector that represents the position of each token in the sequence.

The encoder 502 includes multiple self-attention layers. The self-attention layers are responsible for determining the importance of each input token in generating the output. The self-attention layer allows the model to compute relationships between different parts of the input sequence 506. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 502 uses a multi-head attention layer 512. The multi-head attention layer 512 uses multiple self-attention layers operating in parallel on different parts of the input data, producing multiple representations. The multi-head attention layer 512 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 516.

The feed forward layer 516 comprises a series of fully connected layers and activation functions. The feed forward layer 516 transforms the output of the multi-head attention layer 512 into a suitable representation for the final output. The feed forward layer 516 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a ReLu. The output of the feed forward layer 516 is used as input to the next layer in the encoder 502.

The encoder 502 also comprises a number of normalization layers, such as a normalization layer 514 and a normalization layer 518. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 518 is the final output from the encoder 502 and it is a vector representation of the input sequence 506. The final output from the normalization layer 518 is used as input to the multi-head attention layer 528 of the decoder 504.

The decoder 504 decodes the input sequence 506 to the original data format. Similar to the encoder 502, the decoder 504 shares the core elements of positional encoding, self-attention, and feedforward layers. As depicted in transformer model 500, the decoder 504 comprises a masked multi-head attention layer 524, a normalization layer 526, a multi-head attention layer 528, a normalization layer 530, a feed forward layer 532, and a normalization layer 534. The decoder 504 outputs a decoder output 544 to a linear layer 536. The linear layer 536 is a feedforward network that adapts the dimension of the input to the dimension of the output. The output of the linear layer 536 feeds into a softmax layer 538. The softmax layer 538 transforms the input into a vector of probabilities. The output of the softmax layer 538 is a set of an output probabilities 540 for the transformer model 500. The transformer model 500 then picks the word corresponding to the highest probability and uses it as a best output of the model.

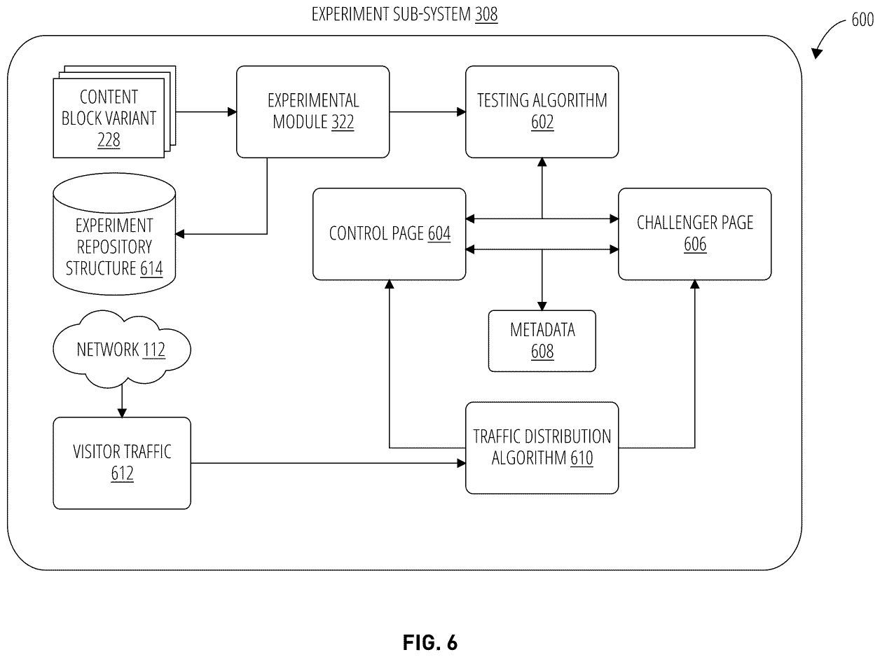

FIG. 6 illustrates a logic diagram 600. The logic diagram 600 is an example of an experimentation framework for experiment sub-system 308 interoperating with the content management system 302. The logic diagram 600 illustrates an example of dynamic content optimization through structured testing. This involves creating multiple content block variants 228 and evaluating their performance against pre-defined criteria. Embodiments are not limited to this example.

As depicted in FIG. 6, the logic diagram 600 illustrates an experiment sub-system 308 comprising an experimental module 322 receiving multiple content block variants 228 from the content management system 302. The experimental module 322 implements a testing algorithm 602, such as an A/B testing algorithm. The experiment sub-system 308 includes a control page 604 and a challenger page 606. The control page 604 is a reference implementation serving as the baseline experience. The challenger page 606 is one of the content block variants 228 designed to be tested against the control page 604 for performance improvement. The term “variants” in the context of the experiment sub-system 308 is a collective term for all tested implementations, including both control pages 604 and challenger pages 606. The result of the testing is generation of performance metrics 336 such as statistical significance, which is a computed metric ensuring observed performance differences are statistically valid and not due to random variance.

Each experiment is assigned a unique identifier referred to as an “Experiment ID” for tracking and data aggregation purposes. Standard naming conventions, such as “EXP001” are used to facilitate systematic record-keeping. An experiment repository structure 614 stores experiment pages within a dedicated folder structure e.g. “/experiments/{ExperimentID}/.” The control page 604 is duplicated into this folder, where adjustments are applied to create the challenger page 606.

The control page 604 and/or the challenger page 606 are configured with metadata 608. For example, the control page 604 metadata includes the Experiment ID. The challenger page 606 metadata includes URLs of challenger pages 606 that are listed in the metadata 608 under a dedicated field, enabling automated traffic distribution.

A traffic distribution algorithm 610 allocates visitor traffic 612 from the network 112 among the control page 604 and the challenger page 606. In some embodiments, the traffic distribution algorithm 610 evenly distributes the visitor traffic 612. When there are multiple challenger pages 606, each challenger page 606 receives approximately one-third of traffic.

During experiment execution, a preview feature allows testing personnel to verify variant configurations. A graphical user interface displays active variants for thorough review before launch. Once validated, both control page 604 and challenger page 606 are published, initiating live traffic distribution and data collection. Experiments extending across multiple pages require consistent experiment ID assignment across all relevant pages.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

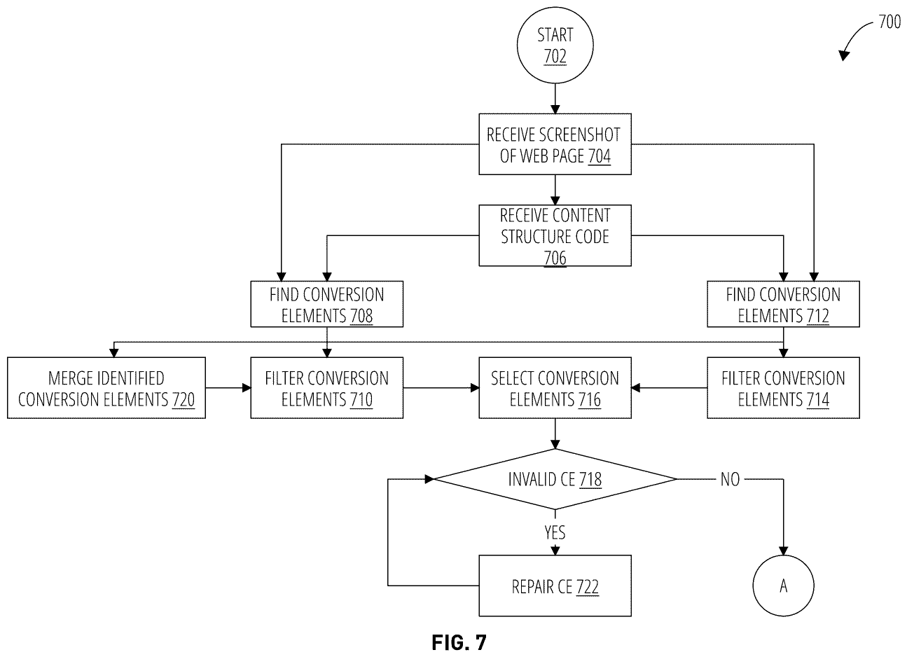

FIG. 7 illustrates a logic flow 700. The logic flow 700 is an example of a detection process performed by the conversion detector module 330 of the content management system 302 to detect conversion elements 332 from digital content information 124. Embodiments are not limited to this example.

As depicted in the logic flow 700, the detection process begins at start 702. At block 704, the logic flow 700 receives digital content information 124 from a digital medium 116, such as a screenshot of a web page of a website. At block 706, the logic flow 700 also receives content structure code 118 for the web page. To precisely predict conversion elements 332, the detection process considers both content structure code 118 of a web page and a visual appearance of the web page via the screenshot. Given that web pages can have very different structures, conversion elements 332 can have different HTML markups. For this reason, the detection process selects conversion elements 332 by also considering their appearance.

The detection process leverages an ML model 310, such as an LLM, to assist in detecting conversion elements 332 from the web page. To increase detection performance, the detection process generates N prompts in parallel to make sure to capture as many conversion elements as possible for a web page, where N represents any positive integer. For example, at block 708, a first prompt is generated for an ML model 310, such as an LLM, to find conversion elements 332 in the screenshot and content structure code 118. In parallel, at block 712, a second prompt is generated for the LLM to find conversion elements 332 in the screenshot and the content structure code 118. At block 720, the conversion elements 332 from block 708 and block 712 are merged into a single list of identified conversion elements 332.

At block 710, the logic flow 700 filters the list of conversion elements 332 found by block 708 to remove “false positives,” which are elements that appear as real conversion elements 332 but are not. For example, an icon on a GUI looks like a CTA button when it is just an icon that does not generate an interaction event 136. In parallel, at block 712, the logic flow 700 filters the list of conversion elements 332 found by block 712 to remove false positives. At block 716, the logic flow 700 receives the filtered output from block 710 and block 712. At block 716, the logic flow 700 selects a final set of conversion elements 332 from the filtered output.

The logic flow 700 uses a set of prompts for an ML model 310, such as a text ML model 312 like an LLM, to assist in certain blocks, such as block 708, block 710, block 712, block 714, block 716, and block 720. For example, the prompt generation module 344 generates a prompt 402 for identifying and selecting conversion elements 332. For example, the prompt 402 includes instructions 404 defining a task that focuses on crafting a valid CSS selector and defining a logical “selector based” path to identify specific elements in the HTML document. The instructions 404 further include the inputs and their purpose. For example, the HTML code provides the page structure and the screenshots offer visual context to identify elements of significance. The instructions 404 further ensure robust outputs. For example, a non-empty JSON is mandated to produce meaningful and actionable results. The instructions 404 also include a task breakdown, such as analyze page structure, consider visual prominence, determine marketing goals, identify interactive elements, include possible hidden elements, and/or filter for text relevant to marketing objectives. The instructions 404 also include output requirements, such as a description of selected marketing conversion element, CSS selector, and a “rationale” explanation of the reason why the element was selected. The instructions 404 further include CSS Selector Constraints, such as avoid CSS selectors which do not follow the W3C CSS standard of CSS selectors, to maintain browser compatibility and ensure selectors directly correspond to HTML structure. The instructions 404 also include error handling, such as ensure non-empty outputs by revisiting the task until relevant results are produced, thereby enforcing comprehensive identification.

At block 716, to select conversion elements, the prompt generation module 344 generates a prompt 402 that includes prompt requirements to select an optimal composition of conversion elements 332 from the web page. For example, the instructions 404 include a role assumption that assigns the AI agent 214 a focused role with an audience persona 224 such as a “Seasoned Web Engineer” with expertise in marketing conversion optimization. The instructions 404 include comprehensive input context, such as uses HTML code for structural insights, incorporates a screenshot to assess visual hierarchy and importance, and leverages two JSON objects of pre-identified marketing elements as starting points. The instructions 404 include preliminary operations, such as analyze page structure, assess visual importance through the screenshot, determine the marketing goal of the page, and filter elements based on high marketing value (e.g., actionable text like “Buy Now”). The instructions 404 include task segmentation which divides the process into preliminary operations (e.g., for context building) and task execution (e.g., refining JSON inputs). The instructions 404 include clear output instructions, such as specifying returning one of the JSON objects and excluding unnecessary text for clarity. The instructions 404 include fallback scenarios to account for situations such as when a JSON input is empty, thereby ensuring seamless handling of edge cases.

The logic flow 700 further includes operations for repairing invalid conversion elements 332. For example, at decision block 718, the logic flow 700 determines whether a conversion element is invalid. If the conversion element is invalid, then the logic flow 700 repairs the conversion element to a valid conversion element at block 722. If the conversion element is not capable of repair, it is discarded from the list.

An example of invalid conversion elements 332 includes CSS selectors of conversion elements 332 that use pseudo-selectors such as “:contains” and “:has”. These pseudo-selectors have meaningful semantics but are not supported by the W3C CSS standard. Therefore, the logic flow 700 replaces them with valid CSS selectors that identify the same elements. To fix selectors and make sure that proper elements are still selected, the logic flow 700 uses the LLM for efficiency reasons. Therefore, the prompt generation module 344 generates a prompt 402 to achieve this task. For example, the prompt 402 includes instructions 404 with prompt requirements to fix invalid CSS selectors. The instructions 404 include an input description, such as HTML code of a web page and a JSON list of conversion elements, each containing properties like “cssSelector” (which is invalid or empty) and a description. The instructions 404 include a task, such as locate each in the HTML structure of the page each element listed in the JSON input where use “:contains” is used to select elements based on their text content and/or use “:has” is used to select elements based on attributes. The task also includes for each element generate a valid CSS selector according to the W3C standard. The instructions 404 include exceptions, such as if “cssSelector” is empty, derive the selector using the description property by locating the element in the provided HTML. The instructions 404 include output requirements, such as the output must strictly be a valid JSON object containing the updated conversion elements with corrected CSS selectors. The prompt 402 is designed for a task requiring precise understanding of HTML and CSS and logical reasoning to infer the correct selectors.

Once the list of conversion elements 332 contains valid conversion elements 332, a final list of conversion elements 332 is passed to control point A for further processing.

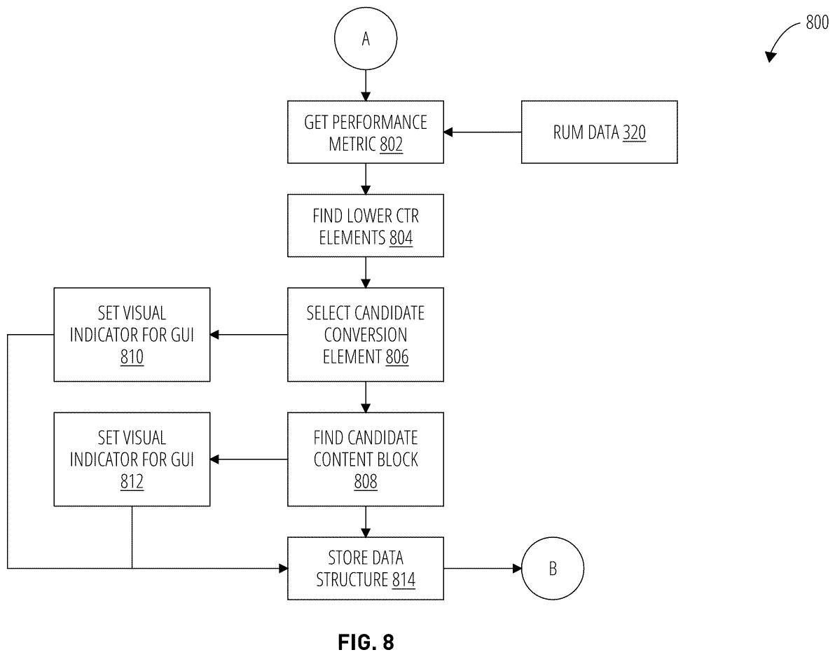

FIG. 8 illustrates a logic flow 800. The logic flow 800 is an example of a selection process performed by the conversion metric module 334 and the content selection module 338 of the content management system 302 to select a candidate conversion element 208 from the list of conversion elements 332 identified from digital content information 124. Embodiments are not limited to this example.

As depicted in FIG. 8, at block 802, the logic flow 800 receives the final list of conversion elements 332 and it gets performance metrics 336 for the conversion elements 332 using RUM data 320. In some embodiments, for example, the performance metric 336 is an engagement metric such as a click-through-rate (CTR) value.

At block 804, the logic flow 800 finds conversion elements 332 with lower performance metrics 336, such as lower CTR values. Lower engagement conversion elements 332 are discovered by looking for a similar page also called a control page (e.g., which has a similar role as landing pages, marketing pages, etc.) which is considered to have optimal user engagement. To find control pages each site was crawled and the content of every page was classified using specific prompts, tagging each page with the most relevant category tags indicating the type of pages. Once pages are classified, an algorithm uses viewed block percentages and CTR RUM data 320 to estimate the user engagement of every page. Finally, it produces a data structure mapping every page with a control page of the same category (the one with best user engagement found in the previous step). Once the control page is found, the conversion elements 332 of the current page CTR are compared with the average CTR of conversion elements 332 on the control page. Below average conversion elements 134 are labeled as “lower engagement” conversion elements 332.

At block 806, the logic flow 800 selects one or more candidate conversion elements 208 from the lower engagement conversion elements 332. At block 810, the logic flow 800 sets a visual indicator for the candidate conversion element 208, such as a red border around the candidate conversion element 208. At block 808, the logic flow 800 finds a candidate content block 204 that includes the candidate conversion element 208 and context information 206 for the candidate conversion element 208. At block 812, the logic flow 800 sets a visual indicator for the candidate content block 204, such as a blue border around the candidate content block 204. At block 814, the logic flow 800 stores the candidate content block 204 with the candidate conversion element 208 in a data structure in the data store 102. For example, the data structure is a table that includes the candidate content block 204, the context information 206, the candidate conversion element 208, and/or the list of conversion elements 332.

Once a candidate content block 204 is found with the context information 206 and the candidate conversion element 208, the candidate content block 204 is passed to control point B for further processing.

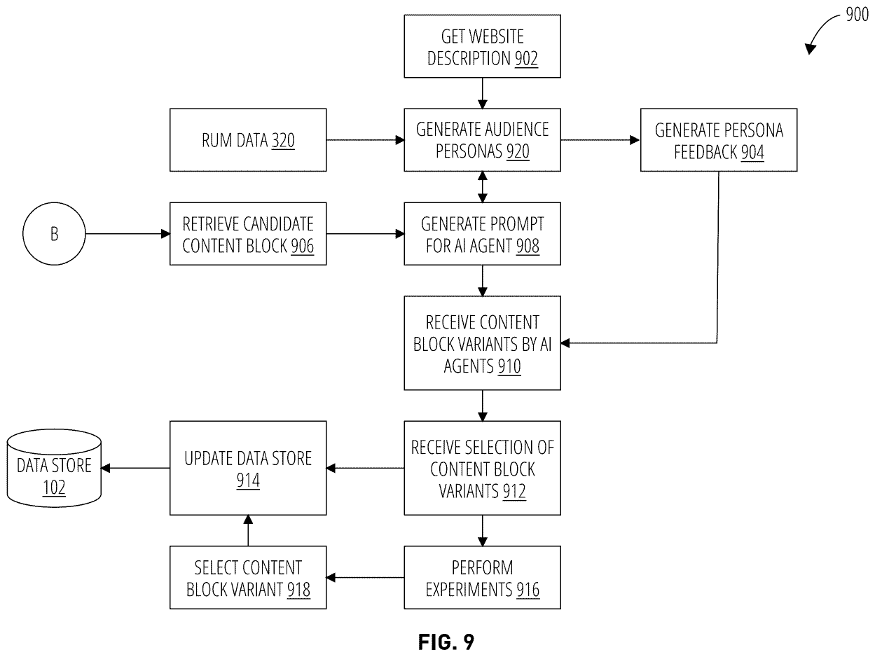

FIG. 9 illustrates a logic flow 900. The logic flow 900is an example of a content generation and testing process performed by various components of the content management system 302, such as agent selection module 342, prompt generation module 344, content update module 346, and experimental module 322 of the content management system 302. For example, the agent selection module 342 selects an AI agent 214 for the candidate content block 204, the prompt generation module 344 generates a prompt 402 for the AI agent 214, the AI agent 214 generates a content block variant 228 for the candidate content block 204, and the experimental module 322 performs experiments on content block variants 228. Based on results of the experiments, the content update module 346 updates the digital content information 124 with a content block variant 228 for a digital medium 116. Embodiments are not limited to this example.

As depicted in FIG. 9, at block 906, the logic flow 900 retrieves the candidate content block 204 identified by the logic flow 800 at control point B. At block 908, the logic flow 900 generates a prompt 402 for an AI agent 214 with an audience persona 224. For example, the AI agent 214 and audience persona 224 is selected from a list of pre-generated AI agents 214 and audience personas 224. In another example, the AI agent 214 and audience persona 224 is generated for the candidate content block 204. For instance, at block 902, the logic flow 900 gets a website description stored in the data store 102 or from an ML model 310, such as text ML model 312. At block 920, the logic flow 900 generates one or more AI agents 214 and audience personas 224 based on the website description, RUM data 320, and/or the candidate content block 204. At block 904, the logic flow 900 generates persona specific feedback, such as through a chat session between a user and an AI agent 214. Information from the chat session, such as a chat history, is used as input to block 910. At block 908, the logic flow 900 generates the prompt 402 for the AI agent 214 as output to the block 910. At block 910, the logic flow 900 generates or receives one or more content block variants 228 for the candidate content block 204 using one or more AI agents 214 in response to the prompt 402 and/or persona feedback from the chat session. At block 912, the logic flow 900 receives a selection of multiple content block variants 228 from a user via an input device. At block 914, the logic flow 900 updates the data store 102 with the content block variants 228. At block 916, the logic flow 900 performs experiments on the selected content block variants 228 using the experiment sub-system 308 and experimental module 322. At block 918, a final content block variant 228 is selected from the content block variants 228 based on experimental results as measured by performance metrics 336. At block 914, the logic flow 900 updates the data store 102 the final content block variant 228.

Specifically, at block 920, the logic flow 900 generates one or more AI agents 214 each having an audience persona 224. The logic flow 900 generates accurate audience personas 224 for each potential visitor of the web page, provides in depth insights about these visitors (e.g., if they were more likely to be teenagers, adults or elderly), and generates descriptions incorporating aspects of their personality, cultural traits and communication habits. All these insights enable creation of accurate, realistic, and actionable descriptions of audience personas 224. A very descriptive audience persona 224 for each visitor of the web page enables AI agents 214 to impersonate visitors using these audience personas 224 to extract feedback to improve digital content information 124 of web pages and thereby marketing results.

Different techniques are used to generate an audience persona 224. In some embodiments, the logic flow 900 generates an audience persona 224 using RUM data 320. In order to determine an audience persona 224 in a privacy-first way, the logic flow 900 extracts device distribution and traffic origin of web pages to estimate the age groups of visitors. The logic flow 900 also uses marketing data from other applications, such as campaign managers, to generate audience personas 224 well aligned with a brand and strategic goals (e.g., current and past marketing campaigns and insights on the user base) with the possibility of importing already existing audience personas 224. The logic flow 900 performs data integrations that include: (1) engagement metrics such as average session duration, bounce rates, and visits segmented by a traffic source (e.g., RUM data 320); (2) geographic distribution such as a breakdown of users by region or city to tailor location-specific strategies; (3) device-specific behaviors such as differences in user behavior based on device type (e.g., mobile users prefer shorter, visually appealing content); (4) referral insights such as specific platforms driving social media traffic (e.g., Facebook, Instagram, Twitter); (5) demographics such as age groups, gender distribution, and income brackets (if available); (6) content references such as popular categories, products, or services users engage with the domain of the site; (7) conversion data such as traffic sources or devices with the highest conversion rates; and/or (8) time-based patterns such as peak usage times to inform scheduling of campaigns or updates.

Specifically, at block 908, the logic flow 900 generates a prompt 402 for an AI agent 214. In some embodiments, the logic flow 900 generates the prompt 402 having an objective of generating detailed audience personas 224 for a campaign targeting the audience of the website. The prompt 402 includes: (1) predefined audience personas 224; (2) user behavior patterns; and/or (3) audience segmentation with percentages. The prompt 402 further includes RUM data 320, such as: (1) a device distribution histogram (e.g., mobile, desktop, tablet usage percentages); (2) traffic source histogram (e.g., organic search, direct, social media, paid ads); and/or page visits and bounce rate.

In some embodiments, the prompt 402 includes step-by-step reasoning to generate the audience personas 224. The step-by-step reasoning includes: (1) understand device preferences by analyzing the device distribution histogram to identify the dominant devices (e.g., mobile, desktop, tablet) used by the audience; (2) infer user behavior based on device type such as mobile users will likely prefer quick, bite-sized content and seamless navigation, desktop users focus on in-depth browsing or professional purposes, and tablet users could indicate a mix of leisure and detailed browsing behaviors; (3) assess traffic sources using the traffic source histogram to determine how users are reaching the site, such as an organic search which indicates intent-driven users looking for specific information, direct traffic which suggests loyal or returning users familiar with the brand, social media that points to discovery-oriented users who engage with visual or interactive content, or paid ads that likely includes users responding to specific campaigns or promotions; (4) segment user groups by combining insights from device preferences and traffic sources to identify distinct audience segments, such as social media-driven mobile users might be young, tech-savvy individuals seeking quick, engaging content, while desktop users from organic search could be professionals or researchers seeking detailed information; (5) define context of engagement to contextualize when and why users engage with the site based on their traffic source and device, such as social media traffic on mobile might indicate casual, on-the-go browsing, while an organic search on a desktop suggests focused research or task-driven engagement; (6) incorporate demographics and psychographics, such as hypothesize demographics like age, gender, and occupation based on usage patterns, or add psychographics (e.g., interests, motivations, challenges) aligned with observed behaviors; (7) identify motivations and pain points such as derive motivations from traffic sources and device usage like social media users might seek inspiration or entertainment or organic search users likely want specific, actionable information, or highlight pain points that a DOMAIN_NAME can solve, such as for example, mobile users might need faster load times or simplified navigation or paid traffic users need clearer value propositions to convert; (8) tailor marketing opportunities to develop actionable strategies for each audience persona 224, such as mobile-first users by investing in responsive design, short-form content, and quick-loading pages, social media users focusing on visually appealing ads, interactive posts, or influencer collaborations, or organic search users to provide authoritative, detailed content; and/or (9) synthesize into audience personas 224 a combination of some or all insights into distinct, well-rounded personas by giving each persona a name, background, and unique narrative, reflect their digital habits, motivations, and challenges in the description, or ensure each audience persona 224 aligns with specific segments derived from the data. The output is an audience persona 224 with persona details such as: (1) a name and demographic attributes such as a fictional name, age, gender, occupation and location, (2) a preferred device such as a most used device and its influence on engagement; (3) traffic source and context such as how and why they access a DOMAIN_NAME; (4) motivations and pain points such as user goals and challenges addressed by a DOMAIN_NAME; and/or (5) engagement strategies & opportunities such as strategies tailored to engage this persona effectively.

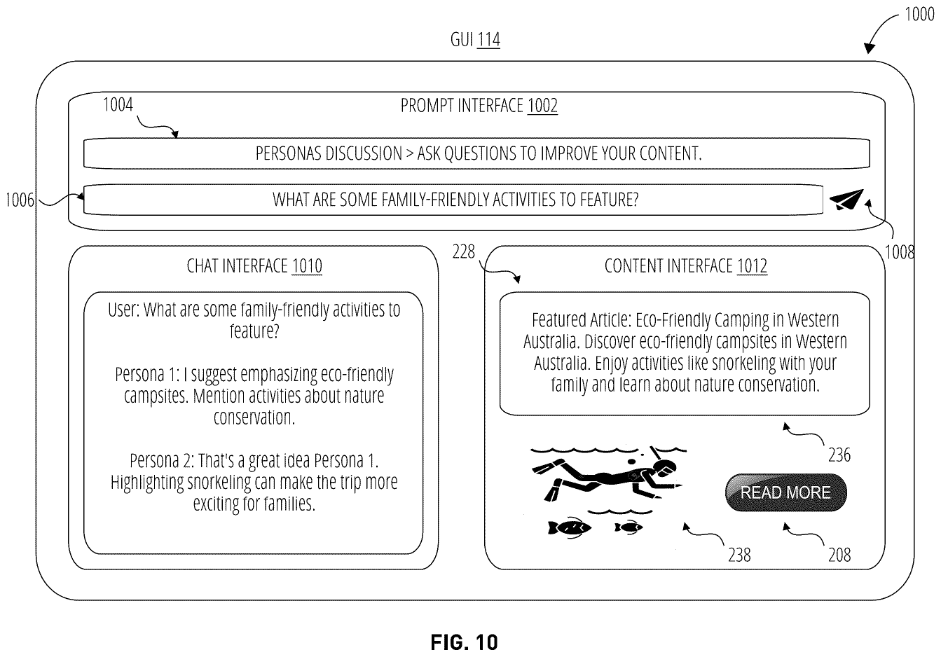

FIG. 10 illustrates a GUI view 1000. The GUI view 1000 illustrates an example of digital medium 116 presenting digital content information 124 on an electronic display of a client device 108. Embodiments are not limited to this example.

To extract feedback using generated audience personas 224 it is necessary to orchestrate a conversation where the audience personas 224 express their voices and collaborate to unify their opinion to propose feedback which expresses the voice of each audience persona 224 to create a better version of the candidate content block 204, with a goal of lifting marketing conversions. The logic diagram 300 illustrates a personas-based agentic workflow implemented using an engine which manages a chat of personas and closes it as soon as AI agents 214 reach a satisfactory compromise. The LLM-based AI agents 214 can act like humans in regular conversations, and they are capable to identifying and acknowledging different point of views on a subject matter and then propose general feedback. It is important to note that there could be situations where opinions of personas is drastically different, and in such cases AI agents 214 will be able to behave like the human personas they impersonate. For example, audience personas 224 with stronger abilities to convince others on the validity of their opinions will win. This is exactly the result that the logic diagram 300 and content management system 302 seeks since it will be slightly more optimized for people who have more sophisticated needs. As a result, the content block variants 228 for a candidate content block 204 will be well aligned with preferences and so they will be more willing to interact with marketing conversion elements 332.

In the beginning the feedback provided will likely be more generic, to improve the user engagement for audience personas 224 represented by AI agents 214. The user of AI agents 214 will interact with these AI agents 214 via chat, where users will be able to ask a question and refine the feedback based on the reflection on the question.

By way of example, as depicted in FIG. 10, the GUI 114 comprises a prompt interface 1002 that illustrates a GUI prompt 1004 that requests a user to interact with an AI agent 214 of the GAI sub-system 304. The GUI prompt 1004 is presented as textual information such as “Personas Discussion>Ask Questions To Improve Your Content.” The prompt interface 1002 includes a text box 1006 to receive a query from a user for a content block variant 228, such as “What are some family-friendly activities to feature?” The user guides an input device to select an icon 1008 to send the query to the content management system 302, which forwards it to the AI agent 214 of the GAI sub-system 304.

The GUI 114 also presents a chat interface 1010. The chat interface 1010 provides a history of interactions between the user and the AI agents 214. The history guides the user to make further queries. The GAI sub-system 304 also uses the history to generate more detail instructions 404 for an AI agent 214 to provide more precise responses and/or content block variants 228.

The GUI 114 further presents a content interface 1012. The content interface 1012 illustrates a content block variant 228 comprising a candidate conversion element 208 and a context information variant 234 for the candidate conversion element 208. The context information variant 234 includes textual information 236 and visual information 238, which are optimized versions of the original textual information 210 and visual information 212 of the context information 206 for the candidate conversion element 208.

As shown in content interface 1012, the candidate conversion element 208 is implemented as a GUI button with the text “READ MORE”. When the user selects the GUI button using an input device, the GUI button generates an interaction event 136 which is forwarded to an event handler and stored in the data store 102. The stored interaction events 136 are part of the RUM data 320 for the data analytics sub-system 306.

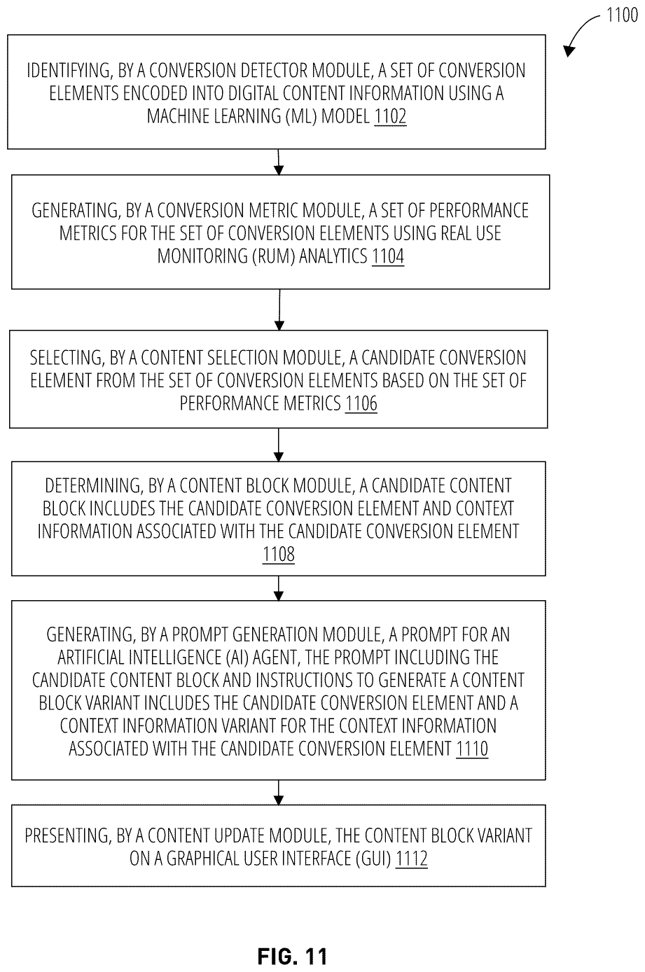

FIG. 11 illustrates an embodiment of a logic flow 1100. The logic flow 1100 is representative of some or all of the operations executed by one or more embodiments described herein. For example, the logic flow 1100 includes some or all of the operations performed by devices or entities within the system 100, logic diagram 200, logic diagram 300, logic diagram 400, transformer model 500, logic diagram 600, logic flow 700, logic flow 800, logic flow 900, and/or GUI view 1000. In one embodiment, the logic flow 1100 is implemented as instructions stored on a non-transitory computer-readable storage medium, such as the storage medium 1322, that when executed by the processing circuitry 1318 causes the processing circuitry 1318 to perform the described operations. The storage medium 1322 and processing circuitry 1318 is co-located, or the instructions is stored remotely from the processing circuitry 1318. Collectively, the storage medium 1322 and the processing circuitry 1318 forms a system.

As depicted in FIG. 11, at block 1102, the logic flow 1100 includes identifying, by a conversion detector module, a set of conversion elements encoded into digital content information using a machine learning (ML) model. At block 1104, the logic flow 1100 includes generating, by a conversion metric module, a set of performance metrics for the set of conversion elements using real use monitoring (RUM) analytics. At block 1106, the logic flow 1100 includes selecting, by a content selection module, a candidate conversion element from the set of conversion elements based on the set of performance metrics. At block 1108, the logic flow 1100 includes determining, by a content block module, a candidate content block includes the candidate conversion element and context information associated with the candidate conversion element. At block 1110, the logic flow 1100 includes generating, by a prompt generation module, a prompt for an artificial intelligence (AI) agent, the prompt including the candidate content block and instructions to generate a content block variant includes the candidate conversion element and a context information variant for the context information associated with the candidate conversion element. At block 1112, the logic flow 1100 includes presenting, by a content update module, the content block variant on a graphical user interface (GUI).

By way of example, the logic diagram 300 comprises a content management system 302 including circuitry and memory storing instructions that when executed by the circuitry performs operations comprising identifying, by a conversion detector module 330, a set of conversion elements 332 encoded into digital content information 124 using an ML model 310. The circuitry performs operations including generating, by a conversion metric module 334, a set of performance metrics 336 for the set of conversion elements 332 using RUM data 320. The circuitry performs operations including selecting, by a content selection module 338, a candidate conversion element 208 from the set of conversion elements 332 based on the set of performance metrics 336. The circuitry performs operations including determining, by a content block module 340, a candidate content block 204 includes the candidate conversion element 208 and context information 206 associated with the candidate conversion element 208. The circuitry performs operations including generating, by a prompt generation module 344, a prompt 402 for an AI agent 214. The prompt 402 comprises the candidate content block 204 and instructions 404 to generate one or more content block variants 228, where each content block variant 228 includes the candidate conversion element 208 and a context information variant 234 for the context information 206 associated with the candidate conversion element 208.

In some embodiments, for example, the circuitry performs operations including presenting, by a content update module 346, one or more of the content block variants 228 on a GUI 114 for review and selection by a user.

In some embodiments, for example, the circuitry performs operations including receiving, by a content update module 346, one or more content block variants 228 from the AI agent 214, and presenting, by the content update module 346, the content block variants 228 on a GUI 114 for review and selection by a user.

In some embodiments, for example, the circuitry performs operations including replacing, by the content update module 346, the candidate content block 204 with a content block variant 228 in the digital content information 124.

In some embodiments, for example, the circuitry performs operations including performing, by an experimental module 322, an experiment on the set of content block variants 228, and replacing, by the content update module 346, the candidate content block 204 with a content block variant 228 from the set of content block variants 228 in the digital content information 124 based on results from the experiment.

In some embodiments, for example, the prompt 402 includes instructions for the AI agent 214 to generate the content block variant 228 using an audience persona 224 defined by a persona information 406, such as a personality profile for an audience member of a target audience segment for the digital content information 124.

In some embodiments, for example, the circuitry performs operations for selecting, by an agent selection module 342, the AI agent 214 from a set of AI agents 214, each AI agent 214 in the set of AI agents 214 including a different audience persona 224.

In some embodiments, for example, the digital content information 124 includes content structure code 118, content style code 120, or content interactive code 122 of a web page, and the candidate conversion element 208 includes a GUI element that when activated generates an interaction event 136 for the web page.

In some embodiments, for example, the AI agent 214 comprises a text ML model 312 that generates textual information 128, a visual ML model 314 that generates visual information 130, an audio ML model 316 that generates audio information 132, or a multimodal ML model 410 that generates a combination thereof.

In some embodiments, for example, the circuitry performs operations for ranking, by the conversion detector module 330, the set of conversion elements 332 based on the performance metrics 336 to form a rank ordered list of conversion elements 332, and selecting, by the content selection module 338, the candidate conversion element corresponding to a rank value that is above a defined threshold value.

In some embodiments, for example, the circuitry performs operations for determining, by the content block module 340, a position for the candidate conversion element 208 in the digital content information 124, identifying, by the content block module 340, context information 206 for the candidate conversion element 208 in the digital content information 124 within a defined distance of the position, and generating, by the content block module 340, a candidate content block 204 from the digital content information 124 that includes the candidate conversion element 208 and the context information 206 for the candidate conversion element 208.

In some embodiments, for example, the performance metrics 336 comprise a click-through-rate (CTR) metric, a conversion rate (CVR) metric, a dwell rate metric, or a bounce rate metric.

In some embodiments, for example, the circuitry performs operations for receiving, from the AI agent 214, a set content block variants 228 that includes the candidate conversion element 208, performing, by an experimental module 322, experiments for the content block variants 228, generating, by the content conversion metric module 334, performance metrics 336 for the content block variants 228 based on results from the experiments, selecting, by a content update module 346, a content block variant 228 from the set of content block variants 228 based on the set of performance metrics 336, and updating, by the content update module 346, the digital content information 124 to include the content block variant 228 in replacement of the candidate content block 204 for the digital content information 124.

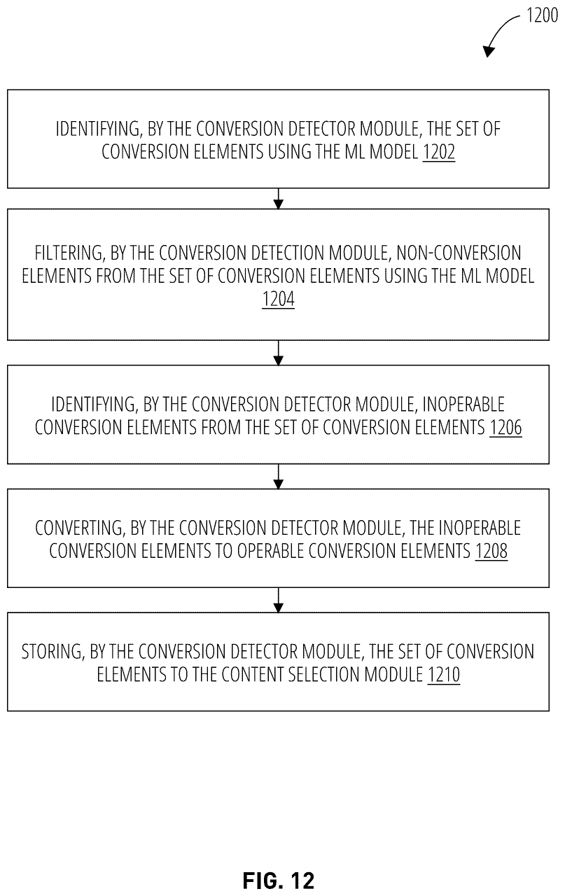

FIG. 12 illustrates an embodiment of a logic flow 1200. The logic flow 1200 is representative of some or all of the operations executed by one or more embodiments described herein. For example, the logic flow 1200 includes some or all of the operations performed by devices or entities within the system 100, logic diagram 200, logic diagram 300, logic diagram 400, transformer model 500, logic diagram 600, logic flow 700, logic flow 800, logic flow 900, GUI view 1000, and/or logic flow 1100. In one embodiment, the logic flow 1200 is implemented as instructions stored on a non-transitory computer-readable storage medium, such as the storage medium 1322, that when executed by the processing circuitry 1318 causes the processing circuitry 1318 to perform the described operations. The storage medium 1322 and processing circuitry 1318 is co-located, or the instructions is stored remotely from the processing circuitry 1318. Collectively, the storage medium 1322 and the processing circuitry 1318 forms a system.

As depicted in FIG. 12, at block 1202, the logic flow 1200 includes identifying, by the conversion detector module, the set of conversion elements using the ML model. At block 1204, the logic flow 1200 includes filtering, by the conversion detection module, non-conversion elements from the set of conversion elements using the ML model. At block 1206, the logic flow 1200 includes identifying, by the conversion detector module, inoperable conversion elements from the set of conversion elements. At block 1208, the logic flow 1200 includes converting, by the conversion detector module, the inoperable conversion elements to operable conversion elements. At block 1210, the logic flow 1200 includes storing, by the conversion detector module, the set of conversion elements to the content selection module.

The method also includes identifying, by the conversion detector module, the set of conversion elements using the ML model, filtering, by the conversion detection module, non-conversion elements from the set of conversion elements using the ML model, identifying, by the conversion detector module, inoperable conversion elements from the set of conversion elements, converting, by the conversion detector module, the inoperable conversion elements to operable conversion elements, and storing, by the conversion detector module, the set of conversion elements to the content selection module. The method also includes where the performance metrics comprise a click-through-rate (CTR) metric, a conversion rate (CVR) metric, a dwell rate metric, or a bounce rate metric.

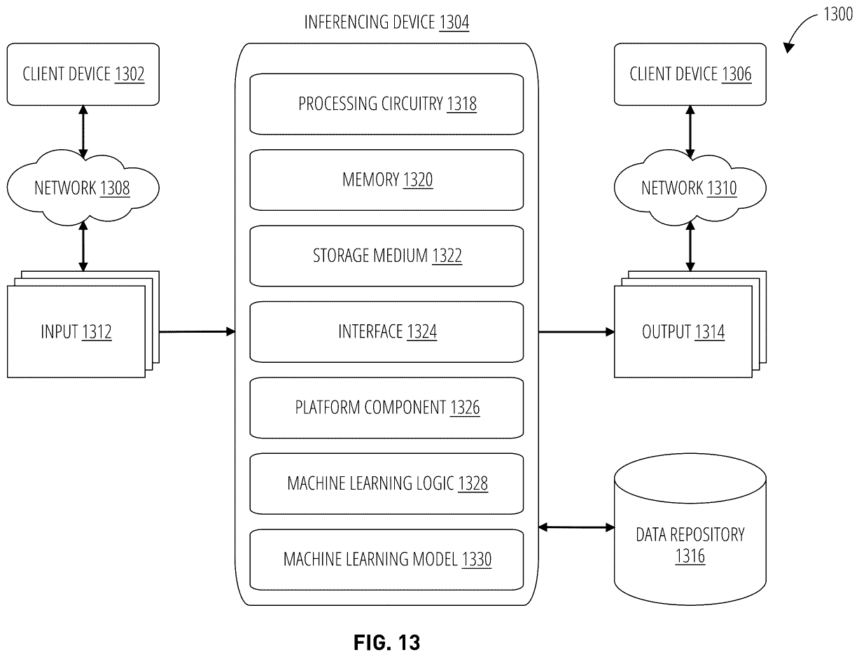

FIG. 13 illustrates an embodiment of a system 1300. The system 1300 is suitable for implementing one or more embodiments as described herein. In one embodiment, for example, the system 1300 is an AI system suitable for generating and/or optimizing digital content information 124 for a digital medium 116 such as a web page of a website as previously described with reference to FIG. 1 through FIG. 12.

The system 1300 comprises a set of M devices, where M is any positive integer. FIG. 13 depicts three devices (M=3), including a client device 1302, an inferencing device 1304, and a client device 1306. The inferencing device 1304 communicates information with the client device 1302 and the client device 1306 over a network 1308 and a network 1310, respectively. In one embodiment, for example, the inferencing device 1304 comprises a server device that implements some or all of the hardware and/or software components of the logic diagram 300, including the content management system 302, the GAI sub-system 304, data analytics sub-system 306, and/or experiment sub-system 308. The client device 1302 and the client device 1306 are devices that implement a GUI interface, such as a web browser, to remotely access digital content information 124 of the digital medium 116 offered by the inferencing device 1304. In one embodiment, for example, the inferencing device 1304 is a client device 1302 or the client device 1306, such as a smartphone, tablet, laptop computer or desktop computer, that executes a GUI 114 to directly interact with the content management system 302 executing locally on the inferencing device 1304.

The information includes input 1312 from the client device 1302 and output 1314 to the client device 1306, or vice-versa. An example of the input 1312 is digital content information 124 from a digital medium 116. An example of the output 1314 is modified digital content information 124 for the digital medium 116, such as a content block variant 228 in replacement of a candidate content block 204 from the digital content information 124. In one alternative, the input 1312 and the output 1314 are communicated between the same client device 1302 or client device 1306. In another alternative, the input 1312 and the output 1314 are stored in a data repository 1316. In yet another alternative, the input 1312 and the output 1314 are communicated via a platform component 1326 of the inferencing device 1304, such as an input/output (I/O) device (e.g., a touchscreen, a microphone, a speaker, etc.).

As depicted in FIG. 13, the inferencing device 1304 includes processing circuitry 1318, a memory 1320, a storage medium 1322, an interface 1324, a platform component 1326, ML logic 1328, and an ML model 1330. The ML logic 1328 executes operations to support the GAI sub-system 304 of the content management system 302. The ML model 1330 is an example of the ML models 310. In some implementations, the inferencing device 1304 includes other components or devices as well. Examples for software elements and hardware elements of the inferencing device 1304 are described in more detail with reference to a computing architecture 1700 as depicted in FIG. 17. Embodiments are not limited to these examples.

The inferencing device 1304 is generally arranged to receive an input 1312, process the input 1312 via one or more AI/ML techniques, and send an output 1314. The inferencing device 1304 receives the input 1312 from the client device 1302 via the network 1308, the client device 1306 via the network 1310, the platform component 1326 (e.g., a touchscreen as a text command or microphone as a voice command), the memory 1320, the storage medium 1322 or the data repository 1316. The inferencing device 1304 sends the output 1314 to the client device 1302 via the network 1308, the client device 1306 via the network 1310, the platform component 1326 (e.g., a touchscreen to present text, graphic or video information or speaker to reproduce audio information), the memory 1320, the storage medium 1322 or the data repository 1316. Embodiments are not limited to these examples.

The inferencing device 1304 includes ML logic 1328 and an ML model 1330 to implement various ML techniques for various ML tasks. The ML logic 1328 receives the input 1312, and processes the input 1312 using the ML model 1330. The ML model 1330 performs inferencing operations to generate an inference for a specific task from the input 1312. In some cases, the inference is part of the output 1314. The output 1314 is used by the client device 1302, the inferencing device 1304, or the client device 1306 to perform subsequent actions in response to the output 1314.

The various elements of the devices as previously described with reference to the figures include various hardware elements, software elements, or a combination of both. Examples of hardware elements include devices, processors, microprocessors, circuits, and so forth. Examples of software elements include programs, applications, application programming interfaces (APIs), or any software.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items is distinct or they is the same, although in some situations the context indicates that they are distinct or that they are the same.

As used herein, in some embodiments, the term “circuitry” refers to, be part of, or include a circuit, an integrated circuit (IC), an Application Specific Integrated Circuit (ASIC), or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements is collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. A method, comprising:
identifying, by a conversion detector module, a set of conversion elements encoded into digital content information using a machine learning (ML) model;
generating, by a conversion metric module, a set of performance metrics for the set of conversion elements using real use monitoring (RUM) analytics;
selecting, by a content selection module, a candidate conversion element from the set of conversion elements based on the set of performance metrics;
determining, by a content block module, a candidate content block comprising the candidate conversion element and context information associated with the candidate conversion element;
generating, by a prompt generation module, a prompt for an artificial intelligence (AI) agent, the prompt including the candidate content block and instructions to generate a content block variant comprising the candidate conversion element and a context information variant for the context information associated with the candidate conversion element; and
replacing, by a content update module, the candidate content block with the content block variant in the digital content information.

2. The method of claim 1, wherein the prompt includes instructions for the AI agent to generate the content block variant using an audience persona defined by a personality profile for an audience member of a target audience segment for the digital content information.

3. The method of claim 1, wherein the digital content information comprises content structure code, content style code, or content interactive code of a web page, and the candidate conversion element comprises a graphical user interface (GUI) element that when activated generates an interaction event for the web page.

4. The method of claim 1, comprising:
identifying, by the conversion detector module, the set of conversion elements using the ML model;
filtering, by the conversion detection module, non-conversion elements from the set of conversion elements using the ML model;
identifying, by the conversion detector module, inoperable conversion elements from the set of conversion elements;
converting, by the conversion detector module, the inoperable conversion elements to operable conversion elements; and
storing, by the conversion detector module, the set of conversion elements to the content selection module.

5. The method of claim 1, comprising:
ranking, by the conversion detector module, the set of conversion elements based on the performance metrics to form a rank ordered list of conversion elements; and
selecting, by the content selection module, the candidate conversion element corresponding to a rank value that is above a defined threshold value.

6. The method of claim 1, comprising:
determining, by the content block module, a position for the candidate conversion element in the digital content information;
identifying, by the content block module, context information for the candidate conversion element in the digital content information within a defined distance of the position; and
generating, by the content block module, a candidate content block from the digital content information comprising the candidate conversion element and the context information for the candidate conversion element.

7. The method of claim 1, comprising:
receiving, from the AI agent, a set content block variants comprising the candidate conversion element;
performing, by an experimental module, experiments for the content block variants;
generating, by the content metric module, performance metrics for the content block variants based on results from the experiments;
selecting, by a content update module, a content block variant from the set of content block variants based on the set of performance metrics; and
updating, by the content update module, the digital content information to include the content block variant in replacement of the candidate content block for the digital content information.

8. A system, comprising:
a memory component; and
one or more processing devices coupled to the memory component, the one or more processing devices to perform operations comprising:
identifying, by a conversion detector module, a set of conversion elements encoded into digital content information using a machine learning (ML) model;
selecting, by a content selection module, a candidate conversion element from the set of conversion elements;
determining, by a content block module, a candidate content block comprising the candidate conversion element and context information associated with the candidate conversion element;
generating, by a prompt generation module, a prompt for an artificial intelligence (AI) agent, the prompt including the candidate content block and instructions to generate a content block variant comprising the candidate conversion element and a context information variant for the context information associated with the candidate conversion element;
receiving, by a content update module, the content block variant from the AI agent; and
presenting, by the content update module, the content block variant on a graphical user interface (GUI).

9. The system of claim 8, wherein the prompt includes instructions for the AI agent to generate the content block variant using an audience persona defined by a personality profile for an audience member of a target audience segment for the digital content information.

10. The system of claim 8, wherein the digital content information comprises content structure code, content style code, or content interactive code of a web page, and the candidate conversion element comprises a GUI element that when activated generates an interaction event for the web page.

11. The system of claim 8, comprising:
identifying, by the conversion detector module, the set of conversion elements using the ML model;
filtering, by the conversion detection module, non-conversion elements from the set of conversion elements using the ML model;
identifying, by the conversion detector module, inoperable conversion elements from the set of conversion elements;
converting, by the conversion detector module, the inoperable conversion elements to operable conversion elements; and
storing, by the conversion detector module, the set of conversion elements to the content selection module.

12. The system of claim 8, comprising:
ranking, by the conversion detector module, the set of conversion elements based on the performance metrics to form a rank ordered list of conversion elements; and
selecting, by the content selection module, the candidate conversion element corresponding to a rank value that is above a defined threshold value.

13. The system of claim 8, comprising:
determining, by the content block module, a position for the candidate conversion element in the digital content information;
identifying, by the content block module, context information for the candidate conversion element in the digital content information within a defined distance of the position; and
generating, by the content block module, a candidate content block from the digital content information comprising the candidate conversion element and the context information for the candidate conversion element.

14. The system of claim 8, comprising:
receiving, from the AI agent, a set content block variants comprising the candidate conversion element;
performing, by an experimental module, experiments for the content block variants;
generating, by the content metric module, performance metrics for the content block variants based on results from the experiments;
selecting, by a content update module, a content block variant from the set of content block variants based on the set of performance metrics; and
updating, by the content update module, the digital content information to include the content block variant in replacement of the candidate content block for the digital content information.

15. A system, comprising:
means for identifying a set of conversion elements encoded into digital content information using a machine learning (ML) model;
means for selecting a candidate conversion element from the set of conversion elements;
means for determining a candidate content block comprising the candidate conversion element and context information associated with the candidate conversion element;
means for generating a prompt for a generative artificial intelligence (GAI) agent, the prompt including the candidate content block and instructions to generate a set of content block variants, each content block variant comprising the candidate conversion element and a context information variant for the context information associated with the candidate conversion element;
means for performing an experiment on the set of content block variants; and
means for replacing the candidate content block with a content block variant from the set of content block variants in the digital content information based on results from the experiment.

16. The system of claim 15, wherein the prompt includes instructions for the GAI agent to generate the set of content block variants using different audience personas, each audience persona defined by a personality profile for an audience member of a target audience segment for the digital content information.

17. The system of claim 15, wherein the digital content information comprises content structure code, content style code, or content interactive code of a web page, and the candidate conversion element comprises a GUI element that when activated generates an interaction event for the web page.

18. The system of claim 15, comprising:
means for identifying the set of conversion elements using the ML model;
means for filtering non-conversion elements from the set of conversion elements using the ML model;
means for identifying inoperable conversion elements from the set of conversion elements;
means for converting the inoperable conversion elements to operable conversion elements; and
means for storing the set of conversion elements.

19. The system of claim 15, comprising:
means for determining a position for the candidate conversion element in the digital content information;
means for identifying context information for the candidate conversion element in the digital content information within a defined distance of the position; and
means for generating a candidate content block from the digital content information comprising the candidate conversion element and the context information for the candidate conversion element.

20. The system of claim 15, comprising:
means for generating a set of performance metrics for the content block variants based on the results from the experiments; and
means for selecting the content block variant from the set of content block variants based on the set of performance metrics.
